(19) United States
(12) Patent Application Publication
(10) Pub. No.: US 2015/0127224 A1
(43) Pub. Date: May 7, 2015

(54) ADVANCED WEIGHT RESPONSIVE SUPPLEMENTAL RESTRAINT AND OCCUPANT CLASSIFICATION SYSTEM

(71) Applicant: Joseph Akwo Tabe, Silver Spring, MD (US)

(72) Inventor: Joseph Akwo Tabe, Silver Spring, MD (US)

(21) Appl. No.: 14/070,527

(22) Filed: Nov. 2, 2013

(51) Int. Cl. B60R 22/48; B60R 21/16

(52) U.S. Cl. CPC B60R 22/48; B60R 21/16; B60R 2022/4858
USPC 701/45

(57) ABSTRACT

Advanced supplemental restraint system associated with occupant detection and weight responsive classification system operable for controlling resistance of the supplemental restraint system such that in an accident, an occupant of the vehicle impacts the supplemental restraint system without injury. The supplemental restraint system is associated with a weight-sensing unit mounted to one or more seats positioned between the seat mounting frame and the floor of the vehicle for sensing the weight of a sitting occupant and for classifying the occupant accordingly, a computerized system is configured for calculating an operating weight value corresponding to the classified weight value, and an airbag system is disposed, comprising one or more airbags in association with a deployment unit configured to inflate the airbags with a deployment force and acceleration that is proportionate to the operating weight value when a collision force is sensed above a predetermined collision force value by a collision sensor.

THIS APPLICATION CLAIMS PRIORITY BENEFITS UNDER 35 USC 119 AND UTILITY APPLICATION Ser. No. 10/680,826, filed Oct. 7, 2003, which is associated with the history chain of application Ser. No. 09/959,502, filed on Oct. 18, 2001, now abandoned, which claims priority benefit from application Ser. No. 09/692,096, filed Oct. 20, 2000 now abandoned, which claims priority benefits from application Ser. No. 08/953,503 filed Oct. 17, 1997, now abandoned, which claims priority benefit from Provisional Application Ser. No. 60/052,435, filed Jul. 14, 1997. Application Ser. No. 10/680,826 claims priority benefits from application Ser. No. 09/692,098, filed Oct. 20, 2000, Now U.S. Pat. No. 6,728,616. This Application claims priority benefits from application Ser. No. 09/959,503, filed on Oct. 18, 2001, Now U.S. Pat. No. 7,426,429. This application further claims benefit from application Ser. No. 11/670,057, filed Apr. 18, 2007, Application Ser. No. 11/585,274, filed Oct. 24, 2006, now U.S. Pat. No. 8,251,397, Application Ser. No. 13/004,912, filed Jan. 12, 2011, which claims priority from Ser. No. 12/910,833, filed Oct. 24, 2010, which claims priority from Ser. No. 12/852,481, filed Aug. 7, 2010, which claims priority from Ser. No. 12/795,567, filed Jun. 7, 2010, which has a history chain therewith. Priority benefits are claimed therewith, as sort in their entirety.

This Application is a Continuation-In-Part of application Ser. No. 10/680,826, filed Oct. 7, 2003, which is associated with the history chain of application Ser. No. 09/959,502, filed on Oct. 18, 2001, now abandoned, which claims priority benefit from application Ser. No. 09/692,096, filed Oct. 20, 2000 now abandoned, which claims priority benefits from application Ser. No. 08/953,503 filed Oct. 17, 1997, now abandoned, which claims priority benefit from Provisional Application Ser. No. 60/052,435, filed Jul. 14, 1997. Application Ser. No. 10/680,826 claims priority benefits from application Ser. No. 09/692,098, filed Oct. 20, 2000, Now U.S. Pat. No. 6,728,616. This Application claims priority benefits from application Ser. No. 09/959,503, filed on Oct. 18, 2001, Now U.S. Pat. No. 7,426,429. This application further claims benefit from application Ser. No. 11/670,057, filed Apr. 18, 2007, Application Ser. No. 11/585,274, filed Oct. 24, 2006, now U.S. Pat. No. 8,251,397, Application Ser. No. 13/004,912, filed Jan. 12, 2011, which claims priority from Ser. No. 12/910,833, filed Oct. 24, 2010, which claims priority from Ser. No. 12/852,481, filed Aug. 7, 2010, which claims priority from Ser. No. 12/795,567, filed Jun. 7, 2010, which has a history chain therewith. Priority benefits are claimed therewith, as sort in their entirety.

### FIELD OF THE INVENTION

Disclosed embodiments provide advanced supplemental restraint system comprising airbag system and smart seatbelt control system. The smart seatbelt control system is configured with the advanced weight responsive supplemental restraint system. Disclosed embodiments further provide an intelligent restraint device configured to erase vehicular fatalities that are incurred due to human negligence, and include all types of accidents. Disclosed embodiments further provide at least a correction device, comprising the concept and theory governing the fact that; all safety devices for all types of vehicles should not discriminatorily protect the driver or frontal seat occupants alone. The theory states that, every individual in a moving vehicle is an occupant and every occupant may incur injuries in a collision. Therefore, every occupant on any seat inside the vehicle must be protected.

### TECHNICAL FIELD OF THE INVENTION

Seatbelts have been used for many years to prevent passengers from injuries in car crashes. Still, people are not paying attention to the importance of the use of the seatbelts. Many loved ones have passed away, and many others have been injured. The government has tried to make seatbelt buckling a law, that all passengers wear seatbelts when riding in a vehicle. Yet, some people still chose to ride without obeying these laws. Disclosed embodiments provide advanced seatbelt control apparatus to include these laws.

Certain embodiments provide a smart seatbelt control system comprising means for locking the seatbelt connectors when connected with the vehicle in motion, to prevent occupants from unlatching the seatbelts.

Some embodiments provide apparatus for monitoring occupied seats when a passenger is on any of the seats and not wearing the seatbelt, providing means to shut off the engine until the occupant is belted. Disclosed embodiments further provide apparatus for informing the driver of the vehicle of the occupants attempt to unlatch the seatbelt while the vehicle is in motion. It is also very important to see that, seatbelt technologies be advanced to prevent the live of our love one's like our beloved Princess. It is for these reasons, “The death of the beloved Princess,” and the public information about the cause of other deaths that applicant has developed a technology that will prevent such fatalities in the future. This technology if applied could have kept the Princess on her seat and reduced the amount of injuries that she and others sustained. The common safety alert incessant has been “Speed Kills,” ‘Buckle Up,” “Don't Drink and Drive.” These are simplistic wordings and disclosed embodiments provide apparatus to enhance these doctrines on our daily practices. Therefore, it is the object of disclosed embodiments to provide means of buckling up before the vehicle could be put in motion. It is another object of disclosed embodiments to ensure that all drivers and passengers take precautionary measures and wear seatbelts before the vehicle is engaged in motion.

### BACKGROUND OF THE INVENTION

Despite the increased use of seatbelts, the estimates of occupants without seatbelt use for 1997 alone were 44 percent passenger car occupants and 49 percent light truck occupants who where involved in fatal crashes without wearing their seatbelts. In 1998, about 19 million people in the United States cultivated the habit of buckling up, but this did not erase the fact that failure to wear safety belts by others will contribute to the more fatalities that are overtaking single traffic safety related accidents. Considering the estimation that safety belts have save 9,500 lives each year is undoubtedly believed that if more people in addition to the 19 million had worn their seatbelts, more people could have been saved.

The traditional lab and shoulder belt does not protect occupants when the occupants are not belted. That is the primary reason the airbags and the smart airbags are designed to assist in these conditions. However, the configuration of the advanced weight responsive supplemental restraint computer system in “Smart Airbag” and “smart seatbelt control system” are appropriate in responding to all accidental conditions, including the existing problems. Disclosed embodiments provide smart seatbelt control system “SSCS” comprising sensors disposed within the seats fixed surfaces and the floor of the vehicle to determine the occupied seats and also the positions of the occupants and enable signal communication thereof. Disclosed embodiments further provide apparatus configured for preventing the vehicle from engaging in motion when any of the occupants is unbelted, which reduces the risk associated with driving without the seatbelt being buckled. Disclosed embodiment is further configured to eliminate injuries from the after effects of accidents. The seatbelt is further configured with the airbag is to provide a timely response, and allows effective airbag reaction to collisions to prevent passengers from falling forward when an impact is enabled.

In order to avoid some of the above problems, related prior art devices have incorporated measurement systems into the seats of some vehicles to gather information about the occupant and to operate the air bag in accordance with that information. These systems generally represent a simple “on” or “off” switch selections. First, if an occupant is not located on the seat, or does not trigger certain secondary detectors, the restraint system is disabled. If the detector properly senses that there is an occupant in the vehicle, the air bag is simply “enabled”. These systems have no way of identifying a changing occupant and correcting the occupant's changing data.

This is exemplified by U.S. Pat. No. 3,861,710, to Okubo, issued Jan. 21, 1975, which shows an incremental airbag deployment through incremental signal communication, but does not show how occupants are classified to enable variable deployment of the airbag. U.S. Pat. No. 4,806,713, issued Feb. 21, 1989, to Krug et al., which shows a seat contact switch for generating a “seat occupied” signal when an individual is sensed atop a seat. The Krug et al. Device does not have the ability to measure the mass of the seated individual.

U.S. Pat. No. 5,071,160, issued Dec. 10, 1991, to White et al., provides the next iteration of this type of system. A weight sensor in the seat, in combination with movement detectors, determines if it is necessary to deploy an air bag. If an air bag is deployed, the weight sensor determines what level of protection is needed and a choice is made between deploying one or two canisters of propellant. First, the weight sensor is located in the seat itself, which inherently leads to inaccurate readings. Second, the level of response has only a handful of reaction levels, thus the occupant not corresponding to one of these levels may be injured due to improper correlation of deployment force associated with the inflated air bag. U.S. Pat. No. 5,161,820, issued Nov. 10, 1992, to Vollmer, describes a control unit for the intelligent triggering of the propellant charge for the air bag when a triggering event is detected. Vollmer's device provides a multiplicity of sensors located around the occupant seat so as to sense the presence or absence of a sitting, standing, or kneeling occupant. The Vollmer device is incapable of sensing varying masses of occupants and deploying the air bag with a force corresponding to the specific occupant weight. Rather, the Vollmer seat and floor sensors ascertain whether a lightweight object, such as a suitcase, is present or a relatively heavier human body. None of the above inventions and patents, taken either singly or in any combination, teaches or suggests the teachings of the present invention.

U.S. Pat. No. 5,232,243, to Blackburn, et al, issued Aug. 3, 1993, uses a film with electrical characteristics with changeable state. Blackburn, et al apparatus teaches a system that sends signals indicative of occupant's presence, but would not classify the occupants to enable a deployment force that would not cause further injury to the occupant.

U.S. Pat. No. 5,330,226, to Gentry, et al., issued Jul. 19, 1994, teaches an apparatus for controlling actuation of occupant restraint system and includes displacement sensors on the dashboard and an infrared sensor on the headliner for sensing the location of the occupant. The invention of Gentry, et al. has no way of classifying changing occupants to enable variable force airbag deployment to protect occupants without causing any further injury to the occupants.

U.S. Pat. No. 5,413,378, to Steffens, Jr., et al, issued May 9, 1995, uses position sensors and weight sensors to sense occupants, but the deployment of the airbag is controlled by a controller operable for selecting a discrete control zone to regulate a vent valve. Steffens, Jr., et al, fails to implement a system that is capable of sensing occupant's actual weight measurement and set airbag deployment based on the data. Besides, the system of Steffens, Jr., et al, has no way of classifying changing occupants.

U.S. Pat. No. 5,707,078, to Swanberg, et al., issued Jan. 13, 1998, teaches airbag with adjustable cushion inflation, which includes a valve member in a module to change the size of the inflation outlet through which inflation fluid flows into the airbag cushion, but is not controlled by the occupant's weight. Thus, the invention of Swanberg, et al. fails to teach airbag assembly that is configured with a classification system to produce a device that would enable airbag deployment at a force that would not cause further injury to the occupant.

U.S. Pat. No. 5,746,467, to Jesadanont, issued May 5, 1998, directed to automatic safety car seat by using tension springs so that the backrest is pushed to recline backward due to the action of the spring, and this still fails to teach seatbelt/airbag assembly that is configured with a classification system to enable seatbelt tension/airbag deployment force that would not cause further injury to the occupant.

U.S. Pat. No. 5,785,347, to Adolph, et al., issued Jul. 28, 1998, directed to occupant sensing and crash behavior system which determines the presence and location of an occupant to enable the deployment of an airbag, but fails to teach airbag assembly that is configured with a classification system to enable seatbelt tension/airbag deployment force that is proportionate to the occupant's weight and that would not cause further injury to the occupant.

U.S. Pat. No. 5,892,193, to Norton, issued Apr. 6, 1999, directed to compact crash sensing switch with air ducks and diagnostic system configured with crash sensors, latching circuit, and firing circuit. The invention of Norton has no way of classifying changing occupants to enable variable force seatbelt/airbag deployment to protect occupants without causing any further injury to the occupants.

U.S. Pat. No. 5,895,071, to Norton, issued Apr. 20, 1999, directed to compact crash sensing switch with air ducks and diagnostic system configured with crash sensors, latching circuit, and firing circuit. The invention of Norton has no way of classifying changing occupants to enable variable force seatbelt/airbag deployment to protect occupants without causing any further injury to the occupants.

U.S. Pat. No. 6,161,439, to Stanley, issued Dec. 19, 2000, directed to seatbelt tension prediction system configured with an accelerometer and a seat weight sensor having an output signal responsive to the force exerted by a mass on the seat by calculating the average mass reading to predict the exerting force on the seat, but does not have the ability to measure the actual mass of the seated individual and has no way of classifying changing occupants to enable variable force seatbelt/airbag deployment to protect occupants during an accident without causing any further injury to the occupants.

U.S. Pat. No. 6,259,167, to Norton, issued Jul. 10, 2001, still was filed only after the parent application of the current invention was made public, though failed in its entirety to show how occupant's data could be monitored and corrected.

U.S. Pat. No. 6,260,879, to Stanley, issued Jul. 17, 2001, directed to air bag suppression system using a weight sensor, a seatbelt tension monitor, and a capacitive sensor for controlling the inflation of an air bag, but does not have the ability to measure the actual mass of the seated individual and has no way of classifying changing occupants to enable variable force seatbelt/airbag deployment to protect occupants during an accident without causing any further injury to the occupants.

U.S. Pat. No. 6,407,347, to Blakesley, issued Jul. 18, 2002, though attempted to use strain gauges after the parent application of the current invention was filed, still fails to distinguish a proper means by which occupants data could be monitored.

U.S. Pat. No. 6,677,538, to Cook, Jr. et al, though uses strain gauges for a vehicle weight classification system, the approach of Cook, Jr., et al. is limited to using analog signal processing technique without revealing a proper means by which occupant's weight could be monitored and the data properly controlled to keep the occupants from sustaining body injury during an accident. Besides, Cook, Jr., et. al., issued Jan. 13, 2004, This Application was filed only after the parent application of the current invention was made public, but still fails to show how occupants data could be corrected.

U.S. Pat. No. 6,609,054, to Michael, issued Aug. 19, 2003, teaches a classification system that classifies vehicle occupants based on data from an array of sensors, and modules are used to for making airbag deployment force decision, airbag deployment direction, or whether not to deploy the airbag. The decisions by Michael teachings for enabling airbag deployment are insufficient in scope to properly deploy the airbag without causing any more injury to the occupants

U.S. Pat. No. 6,695,344, to Constantin, issued Feb. 24, 2004, teaches an airbag module with a predefined outlet opening for the airbag. The module includes a reinforcement ring for the airbag. Constantin's teachings failed to show how the outlet opening is influenced by the occupant's weight to enable a proportionate deployment force for the airbag.

U.S. Pat. No. 7,011,338, to Midorikawa, et al., issued Mar. 14, 2006, teaches a seatbelt device which prevents an occupant from hitting his face against an airbag during deployment by taking up seatbelt slack before a collision. Additionally, tensioning the occupant prior to collision without a predetermined tensile force that is proportionate to the occupant's weight will only cause further injury to the occupant at the time/before the occupant is met with the airbag.

U.S. Pat. No. 7,047,825, to Curtis, et al., issued May 23, 2006, teaches weight sensor assembly for measuring weight on a vehicle seat. The sensor assembly is mounted between the seat bottom frame and a seat mounting member. Though Coutis, et al., fails to use EPROM for monitoring and classifying changing occupants, their teachings seems to be a reflection of publication by World Intellectual Property Organization, Application Number WO 99/48729 and Patent Corporation Treaty, Application Number US99/06666 originally invented by applicant of the present invention.

### SUMMARY OF THE INVENTION

The smart seatbelt control system works very closely with the smart air bag in the advanced weight responsive supplemental restraint computer system. When the ignition switch is turn on, the computer system will read the information about occupants from all the load cells. If the computer picks any weight signal on any of the load cells, it will record a “1” in the computer memory for each assigned load cell that has an occupant. The Spring Control at the Isolator Switch is configured to deploy a spring carrying current that monitors the contacts of each seatbelt connectors. When the current is restricted or cutoff, the spring will retract to unlock the seatbelt connectors inside the open fixed end of the seatbelt housing. When a passenger is seated, the strain gage sensors will provide electrical responses to the applied bending, stretching, or pressure. The response is electrical signal being transmitted to the computer programmable memory for processing. Safety seatbelts and air bags are the most effective means for reducing the potentials of serious bodily injuries and deaths in automobile accidents.

Disclosed embodiments provide a smart seatbelt control system configured to provide some unique potential of reducing the crash fatalities and reducing injuries to a minimum. Disclosed embodiments further provide a seat monitoring apparatus configured to inform passengers to use the seatbelts and avoid fatal injuries in most accidents as a result. For individual protection, seatbelts should always be worn before the vehicle is engaged in motion and when the vehicle is in motion. Disclosed embodiment is further configured with the starting system of the vehicle. Once the vehicle is started and put to motion, energy is created to regenerate different rate of motion as a function of speed. Speed is the main determinant of how serious a crash can be. This speed is what generates the force that human body receives in an accident.

It is true that people take forces of impacts for jokes, but without the use of seatbelts and air bags on high-speed accidents, kids and pregnant women will always be punished by a very little impact force. Therefore, it is important that all occupants in the vehicle wear seatbelts always. The proper positioning of the seatbelt on occupant's body is very important. Disclosed embodiments provide the occupants with maximum protection to reduce the bodily injuries that they may sustain. Improper positioning of the seatbelt can also cause injuries during accidents and without the seatbelt, frequently people will loose their lives. Therefore, occupants should always wear their seatbelts and observe all the regulations and attachments about the seatbelts. Children and all occupants need protection when riding in a vehicle. So, it is practical to see into it that, all children and vehicle occupants are restrained when riding in any vehicle. If a child or any occupant is not restrained, during accident, the occupant may strike the interior parts of the vehicle and sustain injuries. It should have been suggested that car safety restraints be designed in a way that would prevent the vehicle from starting, if any or all of the occupants are not belted. Disclosed embodiments provide a restraint device configured to protect every occupant in the vehicle.

Disclosed embodiment prevents the vehicle from starting if any or all of the occupants are not wearing their seatbelts. Certain embodiments provide a seatbelt system configured to protect every individual in the vehicle. Some embodiments provide means to prevent the vehicle from starting when any or all of the occupants are not wearing their seatbelts. The smart seatbelt control system is further configured with a processor operable to check and make sure that all occupants are belted. If any of the occupant is not wearing the seatbelt, the processor will assign a “0” signal to the control module to initiate the shut off of the ignition switch. The smart seatbelt control system is further configured with a control module operable to activate an audiovisual or human voice response to alert the driver of the vehicle about the specific seat location number bearing the unbelted occupant. If the occupant is still not belted, the control module will then energize the cutoff switch to shut off the engine “5” minutes after the human voice response.

The time required to shut off the engine is adjustable, so that different states or the government could regulate the cutoff time. The computer system is programmed to recognize the number of seatbelts that are available and the number of occupants that are supposed to fill the seats, through the use of the counter or accumulator. The counter is embedded inside the seatbelt processor and receives the load cell signals each time an occupant takes any of the seats. All signals are in binaries, and the transistorized switches are operable for kicking on and off on time for the signals to be transmitted to other devices. Certain embodiments provide a smart seatbelt buckling system that senses and recognizes the number of occupants that are on the seats. The control module signals the cutoff switch when any of the occupants is sensed to be unbelted. Once the seatbelt is buckled and the vehicle in motion, a magnetic switch mechanism (magnetic cylinder) is configured to activate a lock. The lock is to prevent the occupants from unbuckling the seatbelts until the vehicle comes to a complete stop and the key switch turned off or an override switch pushed in.

Disclosed embodiments further provide optoisolator switch comprising electrical means operable to activate the lock that will keep the seatbelt fixed-end and the moveable-end in place, to prevent unbuckling of the seatbelt while the vehicle is in motion. That is, once the engine is started and the occupants are belted, certain embodiments provide the magnetic cylinder operable to prevent unbuckling of the seatbelt unless the engine is shut off or the override switch is closed. When the override switch circuit is closed or the ignition switch is turn off, the magnetic cylinders would de-energize the magnetic field. The applicant understands that many attempts have been made to improve automotive safety through the use of seatbelts. The applicant also understands that once the seatbelt is buckled, occupants occasionally unbuckling the seatbelts. This type of behavior makes the seatbelt useless and very when riding in a vehicle, considering the number of unpredictable accidents that occurs daily. Therefore, it is the object of disclosed embodiments to totally and precisely protect all occupants from unbuckling the seatbelt when the vehicle is in motion or the engine running. It is understood that the object of some disclosed embodiment is not only to protect the driver alone, but also to protect every occupant therein.

Disclosed embodiment does not prevent the ignition key from being inserted into the keyhole of the starting switch. The smart seatbelt control system is configured to let the driver insert the ignition key into the key slot, but other devices are operatively configured to check and count the number of occupants in the vehicle. Once the numbers of occupants are known, the seatbelts on the counted seats will be checked for proper latching. If any occupied seat is found unlatched, a human voice auditory chip will be activated to release a human voice-warning signal to warn the driver about the unlatched seatbelt. The human voice auditory chip is configured to release the specific seat number that has the unbuckled occupant.

The load cell is further configured to always check for the presence of an occupant. If an occupant is present and is a child, the processor will realize this fact through load cell to processor signal communication operable to make sure that the child-seat is properly secured and tensioned. The occupant sitting position counter is configured with the seatbelt processor for counting the number of occupants that are in the vehicle. Disclosed embodiments provide apparatus operable to identify the seat locations that have the unbelted occupants in communication with the processor. Also, the counter is further configured to carry all it's counting in the batch mode and allow the BIOS to talk to the processor. Disclosed embodiments further provide a smart seatbelt control system in association with the BIOS operatively configured to control signal communications to other associated devices. Accordingly, each time any of the load cell circuit is closed, the counter will signal the processor, which will then use the BIOS to process other switches and check for the seatbelt buckling for the occupied seats. The counter will stop counting when the load cells are on no occupant mode or opened circuit.

The processor is further configured to record in the memory, the number of seats counted every time the counter output a signal to the processor's input. The input signal to the seatbelt processor is what the processor uses to feed other devices so that proper and accurate protection can be ascertained. As the counter picks signals from the load cells, the other switches are energized to carry on their tasks. The voice auditory chip is incorporated in the control module to warn of the unbelted occupant when detected. The voice auditory chip response is the first output signal when an occupant is detected for not wearing the seatbelt. The latch relay will open at the end of each count, enabling the other switches to be processed. The control module is configured to check for the operation of the other devices and switches. If any malfunction switch is detected, the voice auditory chip relay would activate a user define message indicative of the problem quo for possible repairs. The control module is further configured to check the optoisolator switch. If the seatbelt is latched, the optoisolator will send a “1” signal to the control module to stop processing. If the seatbelt is not latched, the optoisolator will send a “0” signal to the control module to continue processing. That is, the optoisolator controls 1/0 signal for isolation.

The optoisolating circuit is configured with a light emitting diode “LED” communicatively connected to the output of the isolator to suggest activation of the seatbelt to the control module input. If the signal is “0,” the control module will send a warning human voice signal out to the driver, addressing the seat number and the unlatched behavior of the occupant. The cutoff switch will then be energized if the occupant is still not belted. Disclosed embodiments further provide a boot program in communication with the computer device. The computer device further comprises ROM and BIOS chip further configured to check for any occupant on any of the seats. All the information will then be sent to the address line. The boot manager also assumes control of the start up process and loads the operating system into ROM. The operating system comprises a chip communicatively connected to the BIOS to manage all operations, execute all programs, and respond to signals from the hardware. Certain embodiments provide transistorized switches being operable to create and transmit binary information to enable logical thinking inside the computer and to speedup signal communication therein.

When the seatbelts are connected, the mobile connectors for the seatbelts would activate a magnetic switch. This switch will automatically signal the computer control module that the occupant is belted. The signal for an occupant presence is “1,” and a “0” signal is for an unbelted occupant. The seatbelt actuating switch could be of different types. A “1” transmission signal is when the seatbelt circuit is closed. A “0” transmission signal is when the seatbelt circuit is opened. The seats are coded so that the computer counter can tell the exact seat number that has the unbelted occupant. An insulated cable that has an attaching block and terminals at each end is assigned to each seatbelt positive ends. When the occupant is not belted, the circuit in the seatbelt ends will be opened. And when the occupant is belted, the circuit will be closed, thereby letting current to flow through the coded line to the processor for the seatbelts, in communication with the computer.

Some embodiments provide a seatbelt control system comprising a double circuit system for the processor operable to read the “0s” and the “1s” in two-wire process. That is, two wires will enter the circuit, and if there is a current from the coded line, the line would communicate a “1” from the terminal. If there is no current, the line would communicate a “0” from the other terminal. In case of any current failure, the seatbelt can be disconnected manually, by recognizing that there is a ‘0” reading at the isolator. The arrangements of the electrically conducting wires for the seatbelt circuits are for signaling the computer when in closed or opened circuit to initiate a lock when the circuit is closed. The lock is to keep the seatbelt connectors locked at all times while the vehicle is in motion. That is, with the closed circuit occupants would not be able to disconnect the seatbelt until the circuit is opened. This can only be initiated in two forms,

(1) The driver has to come to a complete stop and turn the key switch off to let the occupant unlock or unlatch the seatbelt.
(2) The driver can come to a complete stop, while the engine is idling; and use the omitting switch (override switch) to let the passenger unlatch the seatbelt by pushing in on the switch. The override switch is a push-in button type switch. When pushed in, it opens the circuit, thereby disconnecting the flow of current and also breaking the field for the magnetic lock. This lock can be designed to use different locking means, which also includes a plunger locking means.

The opening of the latching circuit could only be enforced when there is a restriction to current flow. This restriction is initiated by the omitting switch (override switch) or by the key or ignition switch in the off position. The smart seatbelt control system uses these protective measures to extend the protection of occupants in all types of vehicular accidents. In addition, the smart seatbelt control system is so unique in that, it is operable in automatic mode once the passenger takes any of the seats. That is, it is solely the presence and actions of the occupants that transmit all signals while the vehicle is in motion. The seatbelt edges are made of coated fine material to prevent occupants from being cut by seatbelt edges when the vehicle is involved in an accident with the belt tensioned. The load cell, together with the optoisolator and the CPU, reads the occupant's weight, the vehicle current speed before the accident, and calculates the safe seatbelt tension for each occupant. This tension, which is weight dependent, is the applied tension that is required to hold the occupant on the seat, and give the air bag enough room for more effective deployment. The input-voltage to the seatbelt circuit is responsive to the opposition to the flow of current. This current is being monitored and compared to the ratio of the resultant current that leaves the circuit. The circuit is used to achieve the impedance matching for each seatbelt. It also allows signals to be transmitted to human voice auditory signals when the seatbelt is tempered while the vehicle is in motion.

The smart seatbelt control system can also incorporate a multiplexing technique to assign signals to all specific seatbelt locations or paths. This technique uses a time division to provide independent transmissions of the several pieces of information about the passengers. The information is shared on time with the computer and the driver at frequent intervals. All signals are transmitted through a normally opened switch mode which occurs when an occupant is detected for not wearing the seatbelt. A normally closed circuit is enabled when the occupant is detected for wearing the seatbelt. With the closed circuit, the sensors for each location are configured in series so that the same current will be running through the system, until another occupant takes the other seats. When the seatbelt is not worn, the circuit is opened and an alarm or a human voice-warning signal is transmitted for that seatbelt location. When the circuit is opened, the sensors will be in parallel. Accordingly, when the occupant latches the seatbelt, the sensors will be activated; the circuit will then be closed, enabling the activation of the control module to disable signal communication to the cutoff switch.

The ignition switch for the vehicle is further designed to energize the accessories of the vehicle. The exact arrangement of the smart seatbelt control system depends on the number of seatbelts that are in the vehicle. The sensitivity of the seatbelt in relation to the key switch is set so that the seatbelt will not trip the key without a person on the seat. One set of contacts for the key switch is assigned to each seat in the vehicle. Each time a passenger takes any of the seats in the vehicle, one set of contact will be closed for the air bag and the other opened for the seatbelt, until the passenger latches or buckles up. With the opened circuit, the driver will not be able to start the vehicle. Which means future vehicles will prevent drivers from letting their vehicles idle for a long time without the driver's attention. That is, when the driver is not on the driver's seat while the engine is idling, the switch on the driver's seat will stay open. Thereby transmitting a “0” signal to the control module which will then activate the cutoff switch. Another advantage and uniqueness of disclosed embodiments is that, not many deaths will occur because vehicles were left running in garages while the drivers were upstairs sleeping.

Many have been killed with their entire family by inhaling the exhaust fumes from vehicles parked in garages, because the drivers left their vehicles running unattended while they were upstairs. Besides, some people have the tendency of letting their vehicles idle for a long time unattended. In some way, this practice is hazardous to our health and our environment. Disclosed embodiments provide apparatus comprising “smart seatbelt control system” operable to control the maximum idle time that a vehicle can run when left unattended. If the vehicle was already running, with the opened circuit, the control module will energize the cutoff switch to shut the engine off if the driver is not on the seat, or the passenger is still not belted. The weight reaction on the driver's seat will energize the load cells to provide activation of the other seats. When the driver is seated, the circuit on the driver's seat will close, letting the control module know that the driver is seated while the engine is idling

In all, if there is an occupant in the vehicle and the occupant is not on the driver's seat, with the driver's seat being vacant, the control module will still shut off the engine until the driver takes the driver's seat. The seatbelt processor is configured with a counter that detects the seat that has an unbelted occupant and sends that signal to the control module. The control module is configured to signal the cutoff switch that will later shut off the engine “5” minutes after the warning signal is enabled. With the present invention, the driver will not be able to start the vehicle unless the occupant is belted or the driver is on the driver's seat. The control module has a simple timing circuit that controls the amount of time required to cutoff the key-switch if the passenger is still not belted.

The arrangement for the smart seatbelt control system allows the audio messages to come on first, to let the driver know about the behavior of the passenger before the engine is cut off. With this arrangement, if the passenger decides to put the seatbelt on after the audio warning signal, then the circuit will close and every other circuit will return to normal. Disclosed embodiments provide a smart seatbelt control system that, once the seatbelts are connected or latched, with the ignition key on, passengers will not be able to disconnect the seatbelts without the key-switch in the off position. Also, the driver could let passengers disconnect the seatbelt with the use of the omitting switch (override switch), which will let the passenger off while the engine is still running Another unique advantage of this smart seatbelt control system is that, it has no provision for an unbelted occupant. The time switch is connected in parallel with the key switch and carries the omitting switch (override switch), which is used to let off passengers. The same computer system for the Advanced Weight Responsive Supplemental Restraint Computer System for regulating the air bag deployment is programmed to keep track of the unbelted occupants. That is, if the occupant is not belted, the computer will pick the signal and process other devices to react to the unsafe practices.

Some many advantages of the smart seatbelt control system are that, there is no increased air bag pressure due to the fact that the occupant was not belted. Besides, if the air bag pressures are increased to protect unbelted occupants, there will be no protective limits to bigger or smaller occupants. Additionally disclosed embodiments provide a restraint device configured to provide variable control to protect occupants with a force that is proportionate to the weight on the seat. So, by implementing the smart seatbelt control system, occupants of all ages and sizes will be well protected with this smart seatbelt control system and the advanced weight responsive supplemental restraint computer system's technology.

Again, all occupants are protected with this advanced seatbelt technology in smart seatbelt control system, despite the frontal or rearward sitting position. That is, whether the occupant is sitting in the front or at the back seat, they will all be protected by the smart seatbelt control system. This smart seatbelt control system does not discriminate by protecting only the driver. It does protect every occupant in the vehicle. The smart seatbelt control system will let the car start if the driver or the occupant is not wearing the seatbelt, but the system will shut off the engine if the driver attempts to engage the vehicle in motion with any of the occupant unprotected.

The smart seatbelt control system will not let the engine start if the driver is not on the seat. With the advanced weight responsive supplemental restraint computer system, the individual occupants on the front seats would safely control the inflation pressure of the air bag. The buckling of the seatbelts is monitored by the seats counter that checks all the seats for proper and safe buckling conditions. Which means, the size of the occupants on the front seats, and not the absence of the buckling of the seatbelts will generate the increasing inflation pressure for the air bag. Besides, the seatbelts will always be buckled with this advanced technology. In addition, occupants will not suffer the presence and effect of the excess air bag deployment pressure with the presence of the smart seatbelt control system. Protectively, the smart seatbelt control system together with the advanced weight responsive supplemental restraint computer system guarantees total safety for vehicles with air bags. Gratefully, vehicles without air bags will have their occupants well protected. Also, the smart seatbelt control system does not only control the driver's seatbelt latching but also controls the other seatbelts and sitting positions of the vehicle. This also prevents the vehicle from starting when there is no body on the driver's seat. Once the engine is started, the smart seatbelt control system controls the entire safety devices and prevents the driver from driving the vehicle when there is an unbelted occupant.

Another unique future for the smart seatbelt control system is that, once the seatbelt is latched and the engine running, occupants will not be able to disconnect or unbuckle the seatbelt when the vehicle is still in motion or the engine running. This means, occupants will always have their seatbelts on at all times when the engine is running or the vehicle in motion. Any attempt to latch the seatbelt for the sake of starting the vehicle will prevail with disclosed embodiments. This is because once the seatbelt is latched while the engine is running or the vehicle in motion, the occupant or driver will not be able to disconnect the seatbelt until the vehicle comes to a complete stop and the ignition switch turned off. However, prior attempts have been made to safeguard the life of the driver by not letting the engine crank if the driver is not belted. With these attempts, only the life of the driver is protected.

Also, with the prior attempts, once the engine is started, drivers can still unlatch the seatbelt and still be able to continue driving without the driver or the occupants being protected. Accordingly, the smart seatbelt control system is not discriminative in that, it protects every occupant in the vehicle. Some object of this invention is to prevent the vehicle from starting when there is no person on the driver's seat. Another object of this invention is to cutoff the engine if the driver leaves the driver's seat with the engine running for more than a specified time. That means vehicles will not be started if the driver is not on the driver's seat, even if all the occupants are belted. Which means, when the driver leaves the driver's seat, kids on the passenger's seats will not be able to start the vehicle when there is no one on the driver's seat. In part, the programmable memory will prevent kids of certain weight range, with the incorporation of the load cell, to get on the driver's seat and attempt to start the vehicle. The presence of any occupant will energize the load cell.

The load cell for the driver's seat is configured to energize all the other switches after the presence of the occupant is noticed. The counter is configured with the switch to make sure that the occupants are belted. If the occupants are not belted, the counter will inform the seatbelt processor to enable signal communication. The seatbelt processor will then signal the control module, which will then energize a human voice chip warning response. At the end of the warning communication, if the occupant is still not belted, the control module will activate the cutoff switch and the engine will then be shut off after “5” minutes or at the programmed set time. The smart seatbelt control system prevents occupants from unlatching the seatbelt once the engine is running. This means every occupant is provided with total protection with the uniqueness of the advanced weight responsive supplemental restraint computer system.

The decision making for the air bag in advanced weight responsive supplemental restraint computer system will let the smart seatbelt control system to function automatically. The computer keeps track of everybody in the vehicle with the use of the load cell, to make sure that all the occupants are protected. A detailed record is provided for the presence of an occupant. The rapid decreases in cost for microprocessors and associate elements are bringing the computer-based system into almost every advanced safety and technologies. Therefore, the development of this advanced passenger restraint device is less costly, very affordable, and will allow every passenger and driver alike to stay within the law. A device like the smart seatbelt control system is exceptionally hard not to be used by occupants. This device will also constitute significant positive differences to the fatal accidents and injuries. The low cost of the microprocessor of this device is what is leading to the development of “SMART PASSENGER RESTRAINT.”

The smart seatbelt control system is based on its ability to monitor the presence of passengers on any of the seats, compares the belted information and the unbelted information with the data in the memory. The system would decide whether any of the two groups of information agrees with the stored data that has been programmed in the memory.

When the passenger is present, the computer will read a “1.” If the computer sees a “0” at the seatbelt data, it will know that the passenger is not belted and will immediately signal the chip to response to the exact condition, for the exact message to be amplified to the driver.

The principle to this smart seatbelt control system is based on the electronic line signals by the electronic control module. The signals are in analog, which varies with the amount of current at various sitting points where seatbelts and load cells are assigned. These signals are compared with the preset signal levels to form a digital signal, corresponding to the difference in the presence or absence of the passenger on the seatbelt location. The digital signal is then compared with the actual current level corresponding to the seat pattern and the preset current level. By programming the current level to correspond to the configured seats, this device will not only protect adults, but will also protect any kid or person on the seat, regardless of the size. Since the output is a digital signal, this device can be programmed to check the locks at various high-speed crashes and also record the speed before the crash. That is, this computer device is configured to help detect the crash speed, and would record the speedometer reading before the crash. The omitting switch (override switch) is mounted on the dashboard. This switch is of the push in type, which is configured for letting passengers off the vehicle.

When any of the seatbelts is connected, the current to the computer will initiate a magnetic contact between the two metal connectors of the seatbelt housing to keep the latches locked at all times when the engine is running. When the belts are connected, a phototransistor and a light emitting diode “LED” will face each other across the open slit of the optoisolator switch. This diode is a simple switch, which is energized when the applied voltage provides a forward bias. The optoisolator is an optical-coupler, which consist of a light emitting diode “LED” input, optically coupled to a photocell. The photocell resistance is high when the LED is off “0 signal” for an unbelted occupant, and low resistance when the LED current is on “1 signal” for a belted occupant. The interface circuit for the photocell measures the light intensity inside the optoisolator.

The op-amp is the signal-processing interface disposed between the photocell and the latching relay. This op-amp also compares the buckling switch on the LED when the seatbelt is buckled, and the unbuckled signal when the seatbelt is not buckled. The photocell is a sensor or transducer that converts light or optical energy into electrical energy so that the motion of the seatbelt can be properly monitored. The optoisolator circuit monitors the light-intensity inside the fixed end of the seatbelt and switch on the LED when the occupant is not belted. When the occupant is not belted, the light intensity will drop below the specified level. The conductivity or resistance of the photocell inside the optoisolator circuit changes under light exposure. This light exposure is initiated from the load cell switch when closed. Cadmium Sulfide “CdS” could be used for the design of the photocell. When the occupant is belted, the resistance will decrease while the light intensity will increase. The counter and the latching relay will then be energized. The interface circuit is configured to give an output voltage that is proportionate to the light intensity. This output voltage is proportionate to the load cell out put voltage. This voltage is provided to energize the coils of the seatbelt to regulate seatbelt tension so that a proportionate tensional force is ensured when the vehicle is involved in an accident. The generated voltage from the load cell's output is proportionate to the inverse of the resistance.

The control module is further configured to control the energy source of the switches. This control module comprises means to control large amount of power with a minimum of control energy. Also, different types of control module may be used, but the description and workability of the control module employed calls for a control module that would conduct power in either one or two directions. Only the module that conducts current in both directions will be mentioned in details.

The thyristor, which is a silicon-controlled rectifier, may be used for the control module process. Although there are other types that may work equally, only the thyristor will be mentioned in length. There are many types of thyristor that could be used. A thyristor is just like a diode with the exception that it can be turned on at any point in the circle. The thyristor has three terminals; the anode, cathode, and the gate are configured to work in a defined sequence. That is, a current pulse is applied to the gate to start conduction.

Once conduction is started, the pulse is no longer necessary, and the silicon controlled rectifier will remain in conduction until the current goes to “0” or some other means is used to force it to stop the conduction process. The triac thyristor could be employed for this design, and consists of two silicon-controlled rectifiers back to back. This allows current to flow in both directions when turned on. In addition, the triac thyristor is readily available in current rating to specific amps and also in voltage ratings. Accordingly, this triac thyristor consist of electrical isolation “optoisolation” and is configured so logic level voltages can turn it on. It turns on at the first voltage zero “0” after the control voltage is applied and the seatbelt latched. It turns off at the first current zero “0” after the control voltage is removed or the ignition switch in the off position or the override switch pushed in. This will also prevent transients or voltage spike on both the source and the load.

The silicon substrate rectifier is configured for fast switching speed needed to keep every body informed of the necessary safety measures. The triac is very capable of providing such an adequate speed. In all, the silicon controlled rectifier is configured with the computer logic circuit. The seatbelt latching circuit also measures light intensity from the load cell responsive to occupant presence on the seat. An op-amp is provided as a signal-processing interface between the optoisolator and the latching circuit. This op-amp compares the light emitting diodes “LED” for latching purposes when the load cell circuits are closed. When the seatbelt is connected, the blinder will kick out. That is, the blinder will not be inserted into the slit when the seatbelt is latched. The transistor is responsive to the LED for energizing a magnetic field between the two connectors for the seatbelt.

When the key switch is turn off, or when the omitting switch is pushed in, the blinder will insert into the slit to disconnect or break the magnetic field. The insertion of the blinder into the slit allows the occupants to unlatch the seatbelt in an attempt to get out of the vehicle. Also, when the seatbelt is not connected, the blinder will insert into the slit, enabling signal communication to the computer responsive to the seatbelt is not being connected. The seatbelt magnetic switch is embedded inside the optoisolator switch, which is mounted on the fixed structural side of the seatbelt. The applicant understands that the arrangement of the magnetic cylinder and the blinder can be configured differently. But the concept behind the smart seatbelt control system is what the applicant is further claiming, to structurally safe the live of occupants in future accidents. Disclosed embodiments further provide multi-mode control module operable for communications with the seatbelt processor.

The counter tells the processor the number of unbelted occupants in the vehicle and the seat location of the occupant. The key switch is configured to send current to the isolator operable to create magnetic field lines at the ends of the seatbelt connectors. The field lines are strongest at the seatbelt ends when connected and the engine running. The blinder is further configured to break the magnetic force each time the omitting switch is pushed in or the key switch turned off. The object of this invention is to prevent occupants from unlatching the seatbelt when the engine is running or the vehicle in motion. Another object of the present invention is to shut off the engine when the vehicle is involved in any type of accident, preventing the pressurized fuel lines from busting out and fuel reaching the exhaust pipe or any other hot spot around the fuel lines and course flames.

The control module is further configured to receive signals from the vibration sensor for rollover type accident, and from the collision sensor in frontal or rear-end type accident to activate the cutoff switch. Some of the many reasons why this state of the art smart seatbelt control system shut off the engine are because drivers get panic when an accident occurs and lost control of directing the vehicle. By shutting off the engine further reduces other consequences that are associated with panicking with the steering wheel. Also, on very severe accidents, fluid lines sometimes give away due to increased pressure on the lines caused by the force of the collision. With the exhaust temperature at certain degrees or any occurring sparks around the engine, a leaking fuel line will initiate flames and the vehicle will go on fire. Therefore, it is another object of this invention to eliminate further accidents and fatalities after the initial accident. This smart seatbelt control system is configured with the control module to activate the shut off system seconds after the air bag had deployed. The line of force is continuous between the north and south poles of the seatbelt connectors.

This line of force or current flow draws these poles together to keep the seatbelt locked at all times, when the vehicle is in motion. The material used for the seatbelt connectors would have high permeability that will allow the material to conduct magnetic flux. The magnetic flux density will measure the concentration of the magneto-motive force of the seatbelt connectors. That is, a strong magnet will depend on the heavy concentration of the magnetic flux. The electromagnetic reaction is temporal in this smart seatbelt control system device. When current flows through the other end of the seatbelt, and the connectors are latched, they become electromagnet.

The latching of the seatbelts is the principles to the operation of the optoisolator switches. The seatbelt optoisolator switch is communicatively connected to the control module, which is energized when the ignition switch is closed. Once the control module is energized, the cutoff switch circuit will close, holding the control module in the energized state. When the occupant is not wearing the seatbelt, the seat counter and the latching circuits will close for that seat location. The cutoff switch will then be opened for the engine to shut off “5” minutes after the warning message. Seatbelt switches 1, 2, 3, 4 are configured to use logic functions to close and open the counter and the latching circuits. That is, if the passenger is present and wearing the seatbelt, the switch will be closed for that seat location. If the passenger is not wearing the seatbelt, the switch will be opened for the said seat location.

The counter will then receive a “0” logical signal for the unbelted seat location and inform the processor that the occupant on that seat location is not wearing the seatbelt. The processor will then notify the control module, which will then activate the chip to emit a human voice response, and a warning massage will then be voiced out. The control module is further configured to activate a human voice message whenever the circuit for the seatbelt location is opened. The ignition switch is operatively connected to send power to the entire system. All the components of the smart seatbelt control system device are so sensitive in that, tempering with the seatbelt connecting ends will not activate the system. Instead, it will audibly warn the driver that the occupant on the seat location is tempering with the seatbelt. Also, a vibration detector is attached and linked to the system to sense rollover type accidents and activate the cutoff switch to shut off the engine.

The effectiveness of the vibration sensor or detector depends on the proper application and programmed installation. The use of the cutoff switch in any collision or rollover type accidents is to prevent fire hazards or any other type of accident that may occur after the original or initial occurrence. Therefore, proper adjustment of the sensitivity of the vibration system is necessary to avoid false cutoff from vibration caused by bumps. In addition, all accidents that are severe enough to activate the air bag will trigger the cutoff switch “5” seconds after the air bag had deployed. This is to prevent the engine from continuous idling and also to stop any other accidents that could result if the engine stays running after the accident. The time switch provides no time for an unbelted occupant. The advantage of the time switch is to make sure that every occupant riding in the vehicle is protected.

The time delay gives the occupant enough time to comply with the law of wearing seatbelts when riding in a vehicle. Disclosed embodiments further provide the warning massage operable for the duration of the programmed delay intervals. After the delay time has elapsed, the control module is configured to energize the cutoff switch to shut off the engine. The time switch is connected in parallel with the cutoff switch. When the warning signal is operative, the cutoff switch circuit will stay close. After the end of the delay, or the end of the warning message, the cutoff switch will then kick open and the engine will be shut off if the occupant is still not belted. If the occupant decides to wear the seatbelt during the delay, the time switch will be opened and the cutoff switch will then be closed. The computer keeps track of all the activities around the occupants, the air bag, and the seatbelt functions. The computer is programmed to check the seatbelt latches on any of the occupied seat. The load cell provides unique information about the occupant's presence. Certain embodiments provide apparatus configured to monitor the wearing of the seatbelt before the vehicle is engaged in motion to ensure that occupants stay belted and safe, while the vehicle is in motion.

Vehicles without air bags can also take advantage of this smart seatbelt control system. That is, the smart seatbelt control system can use different sensors to sense the presence of an occupant even with older vehicles that have no air bag. In all, the smart seatbelt control system device can be readily installed in older vehicles.

The time constant for the time delay is very important in this smart seatbelt computerized device because the timing and the warning response time determines the performance of the smart seatbelt control system. The device can use different time constant circuit. Some embodiments provide a RL time constant operable to carry the programmable assignments. The RL time constant is the inductor and resistor that are used to design the time circuit for the advanced weight responsive supplemental restraint computer system and the smart seatbelt control system. When current is flowing in the inductor, the current generates a magnetic field buildup around the inductor. If the current is interrupted, the magnetic field collapses very quickly. The magnetic field is allowed to collapse at a controlled rate by an intermediate condition between maintaining the magnetic field and allowing it to collapse rapidly. The resistor determines the rate at which the magnetic field collapses. This time constant is a measure of the time required to broadcast the audible human voice warning message and the time to shut off the engine. The time constant is the specific amount of time required to obtain 100% of the programmable task for the smart seatbelt control system.

Power line transients are ensured to protect any failure within the computer and the electronics. When a passenger sits on any of the seats, the passenger's presence will input a signal on the load cell. The load cell circuit would close and allow output to energize the seatbelt check-switch or counter. The counter will then check to make sure that the switch for the occupied seat is closed. When the switch for the occupied seat is closed, the latching relay will be energized to check if the seatbelt for that seat location is latched. The seatbelt check-switch or counter is closed only when an occupant takes any of the seats. The latching relay switch is only energized when the seatbelt check-switch is closed. The energizing of the latching relay is momentary. Therefore, each time the latching relay is energized, switch “A” will be closed. Once the latching relay is energized, contacts “B” will close, holding the latching relay in the energized state after switch “A” is opened. All the other contacts will follow the same sequence of operation. The seatbelt and the latching relay are arranged so that the contact of seat 1, which is the driver's seat, will supply power to the coils of seat 2, seat 3, and seat 4. The computer is programmed to recognize a pattern of switches, and no occupant will be able to start the vehicle if the occupant is sitting on any seat other than the driver's seat.

The moveable end of the seatbelt has a built in coil in its housing which is rotate-able. The coil is properly winded on two shafts that have wheels at each end. The wheels are rotated as the coils receive collision signal from the collision sensor. A stopper plunger is engaged between the wheels when the coils complete its windings. The seatbelt processor energizes the winding of the coil. That is, the occupants weight from the load cell and the speedometer information of the vehicle are sent to the CPU operable to compute the tension needed to keep the occupant on the seat when the vehicle is involve in a collision. The computed tension for the occupant is then sent to the seatbelt processor to program the coil for that seatbelt housing to rotate and tension the occupant appropriately for the prescribed seat location when a collision is sensed. The other object of this invention is to ensure maximum seatbelt tensioning that is sufficient enough to keep the occupant on the seat without causing any further injury to the occupant, or let the occupant be thrown out of the seat on impact. The tensioning of the seatbelt and the tension on the belt are proportionate to the weight of the occupant on the prescribed seat location.

Another object of this invention is to provide maximum supporting load that will hold the occupant on the seat during collision, while reducing the load acting upon the wheels. The stopper takes out much of the load acting upon the wheels when engaged.

The occupant's measured weight is very useful to measure the power to the coils of the rotating end, comprising the seatbelt tensioning. This power is further divided to signal the tensional circuit to energize the tensioning coil to rotate and tension the seatbelt with a tensional force that is sufficient to hold the occupant on the seat. The energy to the coil of the seatbelt tensioning is only necessary when the vehicle is involved in a collision of the prescribed magnitude. Very little current is made constant at the coil. When the occupant's weight is inputted on the load cell, the load cell will out put this weight in voltage readings. All the voltage readings for the smart seatbelt control system and the advance weight responsive supplemental restraint computer system are very small and they are read in milivolts. When the collision sensor sends a collision signal to the seatbelt processor, the seatbelt processor will signal the coils for the occupied seats so that the coils could be energized and adjust to the appropriate tension needed to safe-guard the occupants from injuries.

The unique object of the invention is to provide a variable tensioning means, since occupants are often thrown off their seats with different collision forces for their different weight values. That is, for each occupant, the power needed to rotate the coil to provide a safe tension on the occupant upon collision is P=I*E. The voltage from the load cell is E. This voltage is the occupant's weight value and all the computations of the rotations of the coils are carried on in binaries. The voltage E, multiplied by the constant current I, provides the necessary pressure that is needed to activate the coil to generate a tensional force that would be compared to pounds per inch, sufficient enough to hold the occupant on the seat without causing any further injuries. The coil will receive a constant current I, and upon receiving the weight signals in voltage reading E, will influence the number of rotations of the coil that will safely protect and tension the occupant, without causing any further injury to the occupant. The ground for the coil is located at the mounting casing of the coil housing.

The smart seatbelt control system further comprises an interface module being disposed inside the control module in communication with the seatbelt processor operable to convert the weight of the occupant and the collision force input into series of signals that the coil can handle. These signals are sent to the coil to act upon, and influence the appropriate number of rotations of the coil to initiate the amount of tension of the seatbelt to keep the occupant on the seat when a collision is sensed. Signals may be sent in one wire at the same time. The transmission of the signals in this multiplexing technique would prompt other devices like the air bag accelerometer to programmable select only the signals that are intended for its use.

In the process of trying to determine the cost of building the smart seatbelt control system, seatbelt manufacturers would realize the very low cost. It is seen here that the same parts are used for the control of the smart airbag deployment force and the smart seatbelt control system. The computer system for the advanced weight responsive supplemental restraint computer system is designed to accept the components of the smart seatbelt control system. Therefore, the only additional future to the computer is the seatbelt processor, the variable electronic tensional coil, the latching relay, and the optoisolator. All the other components are designed to work as described in the body of the present invention, to better improve on automotive safeties.

Disclosed embodiments further provide advancement of occupant's protection to automotive safeties. Accordingly, it is a principal object of the invention to provide a supplemental restraint system having an accurate weight sensor to determine the presence and weight of a passenger.

It is another object of the invention to provide a correlation between the weight of the passenger and the deployment characteristics of the air bag.

Some of the other objects of the present invention are the many advantages as they are introduced in the art,

Occupants are programmed to always wear their seatbelts.

There will be no increased airbag pressure due to the fact that an occupant was not belted.

Vehicles without airbags will have occupants well protected.

The engine is shut-off when any occupant is detected to be unbelted.

The connectors are locked when the vehicle is in motion to further protect occupant's unsafe habits

All the seatbelts are monitored when the ignition switch is turn on.

The system has 100% occupant's awareness and protection before the vehicle is engaged in motion.

The occupant to driver communicating means in relation to the seatbelt latching and the vehicle being in motion is unique.

The engine will cut-off and will not restart if the occupant is still not belted.

Occupants will always be held on their seats at all times while giving the airbag time to deploy more effectively.

The engine is cut-off at a preset time when the driver is not on the driver's seat, thereby preventing carbon inhalation at home garages if left idling and unattended.

The development of the smart seatbelt control system is less costly and more effective in fatality reduction.

These and other objects of the present invention will readily become apparent upon further review of the following specification and drawings.

### BRIEF DESCRIPTION OF THE DRAWINGS

Similar reference characters denote corresponding features consistently throughout the attached drawings.

FIG. 1 is seen to represent a side view of an occupant 110 on a seat 10 of a vehicle using plurality of load cells 15 mounted between the seat mounting surface and the floor of the vehicle to control deployment of the supplemental restraint system of the present invention.

FIG. 2 is seen to represent the optoisolator circuit 70, a blinder 321 not inserted, an op-amp 35, the LED 74, the photo cell 73 and the magnetic cylinder 60 for monitoring and enabling a permanent lock on the belt ends when the vehicle is in motion.

FIG. 3 is seen to represent the optoisolator circuit 70, a blinder 321 inserted, an op-amp 35, the LED 74, the photo cell 73 and the magnetic cylinder 60 for monitoring and disabling a permanent lock on the belt ends when the vehicle is in motion.

FIG. 4 is seen to represent a computer system 500 with all internal elements that enablers signal communication.

FIG. 5 is seen to represent sectional view of the load cell 15 showing the strain gauges 11, a circuit diagram of other components of the present invention is further seen configured with computer 500.

FIG. 6 is seen to represent the seatbelt 17 disconnected from their ends 46, and configured with a wheel 120 and a moveable coil 95, all seen to interface with the optoisolator 70 and the control module 25 FIG. 7 is further seen to represent at least a four sitting positions all configured with at least a load cell 15, at least a switches 18 and include a second switch 88, the ignition switch 01, the cut-off switch 03, the seatbelt latching relay 80 with points A and B as they are related to the control of the seatbelts.

FIG. 8 is seen to represent the transistorized switches 04 and a block diagram of the primary components of the supplemental restraint system of the present invention.

FIG. 9 shows a gas canister 60, a sliding pot 61, the external layer 4, an internal layer 3, an opening 67 for the release of controlled release of gas 65, an air bag 1, an air bag sensor 8 and a combustion chamber 101 all forming the deployment components of at least an area of present invention.

FIG. 10 is seen to represent the interior of the vehicle showing the airbags 1, 2, the dashboard 300, and the pressure sensor 310 mounted on the dashboard for enabling signal communication when active.

FIG. 11 shows the seatbelt monitoring control module 25 showing the front and rear seats circuits configured with a warning system in communication with the human voice chip 020, vibration sensor 300, and the optoisolator circuit 70.

FIG. 12 is further seen to represent at least a four sitting positions all configured with at least a load cell 15 configured but for three sitting positions, at least a switches 18 and include a second switch 88, the ignition switch 01, the cut-off switch 03, the seatbelt latching relay 80 with points A and B as they are related to the control of the seatbelts.

FIG. 13 is a clear view of the seatbelt ends 46 having at least a male connecting ends and a female connecting ends housing at least a harness for signal communications.

FIG. 14 is seen to represent the control unit for the instant invention configured to communicate various interior applications such as seatbelt usage, window up/down, door lock/un-look, heated mirror, engine component operation, wiper/washer on/off and to monitor electronic components operations.

### DETAILED DESCRIPTION OF THE PREFERRED EMBODIMENT

Embodiments provide sensor platform methods and systems comprising apparatus for a supplemental restraint system operable for providing protections to vehicular occupants. Some embodiments described herewith relates to smart detections, smart seatbelt control system, and smart airbag deployment system. For example, in certain embodiments, the apparatus as described comprises a computerized system. In some embodiments, the apparatus as described herein comprises advanced detection system for providing occupant classification. In other embodiments, the apparatus as described comprises sensors affixed between the seat mounting structure and the floor of the vehicle. Yet in other embodiments, sensors are embedded in silicon substrate and etched/fused in nano fiber material to provide an effective pressure sensing platform. Still other embodiments provide apparatus as described comprising a platform array for monitoring occupied seats in a motor vehicle. Still in some embodiments, the apparatus as described comprises a detection apparatus. It is therefore stated that embodiments provided herewith are not limited to their applications in the disclosure. For example, the sensors described herewith further comprise interchangeable applications. As an example, a piezoresistive silicon load cell may be used as a collision force sensor or to embody an accelerometer.

The terminology used herein is for the purpose of describing particular embodiments only and is not intended to be limiting of embodiments. As used herein, the singular forms “a”, “an”, “at least”, “each”, “one of”, and “the” are intended to include the plural forms as well, unless the context clearly indicates otherwise.

It would be further understood that the terms “include”, “includes” and/or “including”, where used in this specification, specify the presence of stated features, integers, steps, operations, elements, and/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that some embodiments of the supplemental restraint system is used concomitantly and/or not used concomitantly with a safety device. This is rather than using the safety device reflection for initial safety operation. In some embodiments, the supplemental restraint system comprises a platform array responsive to occupant's presence. In some embodiments, the supplemental restraint system further comprising a platform array responsive to frontal and rear-end collision. Other embodiments herein describe apparatus configured for protecting vehicular occupants.

The foregoing and/or other objects and advantages would appear from the description to follow. Reference is made to the accompanying drawing, which forms a part hereof, and in which is shown by way of illustration specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims.

Referencing the drawings, wherein reference numerals designate identical or corresponding parts throughout the several views, example embodiments of the present patent application are hereafter described. The numbers refer to elements of some embodiments of the disclosure throughout. As used herein, the terms “and/or” and “at least one of” include any and all combinations of one or more of the associated listed items.

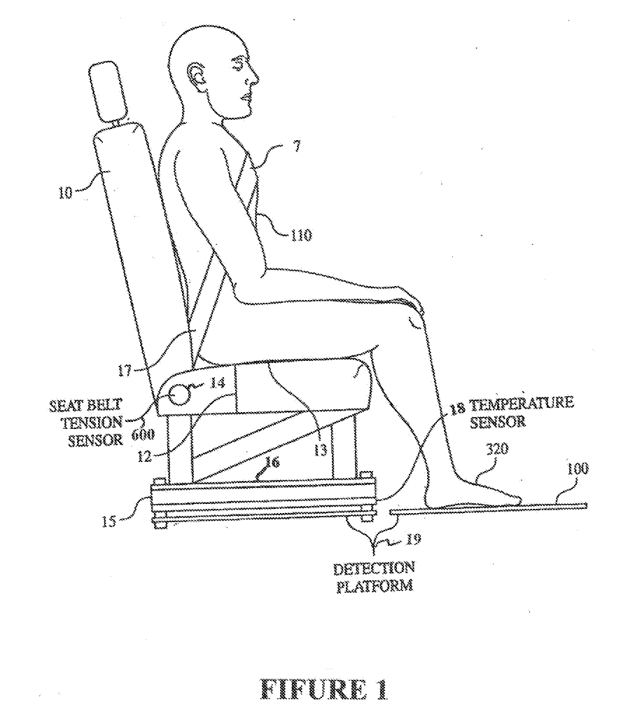

Referring to FIG. 1, embodiments provide a seat 10, being disposed with load cell 15, being operatively configured with human body temperature sensor 18, and securely mounted between the seat mounting frame 16 and the vehicle floor 100 by at least a fastener 14, providing a detection platform 19. Disclosed embodiments provide the detection platform 19 operable for detecting the weight of an occupant 110 on the seat 10 and the weight of the occupant 110 on the floor 100 of the vehicle. Certain embodiments provide the occupant 110, being seated on the seat contact surface 13, and being separated from the mounting frame 16 by a seat cushion 12. Certain embodiments provide the occupant 110 being seated on the seat 10 and the leg of the occupant leg 320 being positioned on the floor 100. Some embodiments provide a temperature sensor 18 being operable for detection of human body and for confirming that the object being detected is a human body. The detection platform 19 is further operable for measuring the actual weight of the occupant 110. Embodiments further provide the occupant 110 wearing a seatbelt 17. Some embodiments provide the seatbelt 17 being disposed with embedded sensors 7 in communication with the seatbelt tension sensor 600. The human body temperature sensor is in association with at least a pressure sensing device.

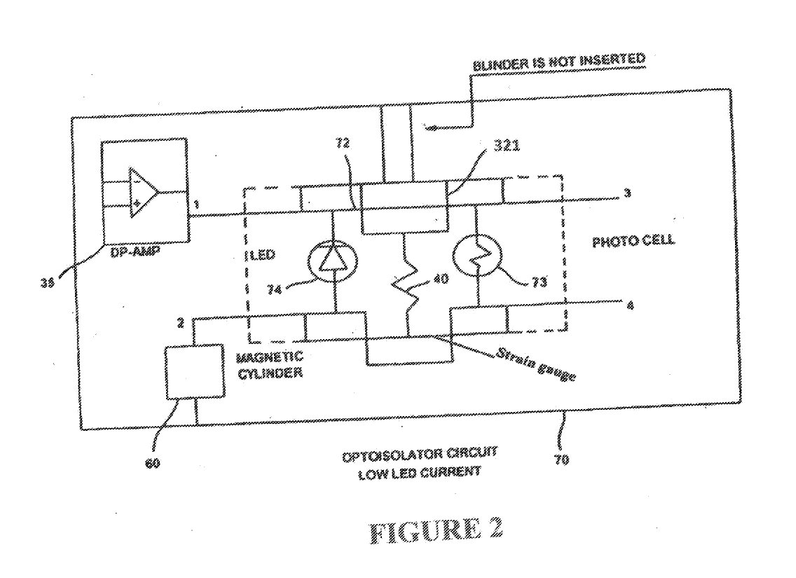

FIG. 2 denotes an exemplary embodiment of an optoisolator circuit 70, configured with at least a magnetic cylinder 60, in communication with load cell 3, configured with a strain gauge 4. At least a LED 74 is configured with a photo cell 73 in communication with at least a blinder 321. Load cell signals 1, and strain gauge signals 2 are amplified by OP-AMP 35. An accelerometer 40 is operable with the blinder 321 to provide rapid response for the insertion of slit 72. The accelerometer 40 further comprises energy harvesting method being disposed with a coil.

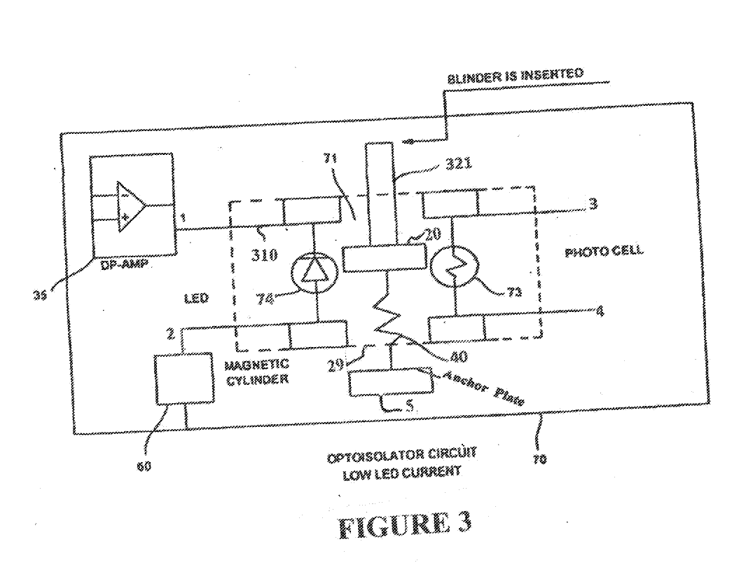

FIG. 3 denotes further exemplary embodiment of an optoisolator circuit 70 showing the blinder 321 being operable with the slit inserted 71. The slit 71 is further disposed with an anchor plate 5 configured with load cell 3 in communication with the strain gauge 4. Further embodiments provide the anchor plat 5 in communication with the magnetic cylinder 60. The LED 74 is configured with the photo cell 73 in communication with the blinder 321. Certain embodiments provide the load cell 3 being disposed with strain gauge 4, The OP-AMP 35 operable for amplifying signal communications, including load cell output signal 1, and strain gauge output signal 2. The accelerometer 40 is configured with the blinder 321, operable for providing rapid response to the operation of the insertion slit 71. Some embodiments provide the load cell 3 being disposed at the gate 29 for communication with the blinder 321 and the cut-off switch 03. In the disclosure, embodiments provide power line transient 310 operable for protection against transient power.

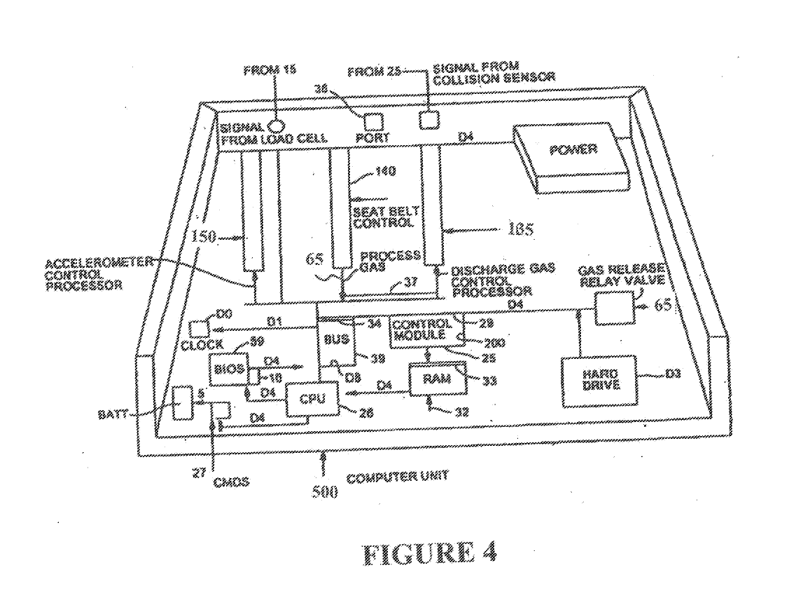

Referring to FIG. 4, embodiments provide a computer unit 500 in communication with load cell 15. The computer unit 500 is further configured with at least a mother board 38 being disposed with at least ports 36, a battery 5, ROM/BIOS 59, a power source 04, RAM 32, CPU 26, CMOS 27, a control module 25 further responsive to pulse signals from the gate 29, an interface module 200, a boot program 08, a BUS 39, an address line 33, an encoder 37, and a clock 00. Disclosed embodiments further provide the computer unit 500 being disposed with a processor 130 operable for regulating the required amount of discharge gas per weight value, in communication with gas release valve relay 42 for releasing of the processed gas 65, a collision sensor processor 135, seatbelt control processor 140 in communication with the load cell for providing signal to a coil, operable to regulate the seatbelt tension according to the occupant's weight, and/or signal from the accelerometer control processor 150, The computer unit 500 is operatively configured with the hard drive comprising cut-off switch 03, in communication with the ignition switch 01. Certain embodiments provide the computer unit 500 configured with EPROM, in communication with load cell 15.

The EPROM includes an emulator being disposed in a housing operatively connected to the EPROM header. The EPROM header is communicatively connected to a circuit board in communication with a microprocessor. The housing further comprise data select circuits configured to hold the occupants weight data. A switch on the housing is configured to be turned on to place the device in programming mode. The EPROM is programmed for sending data through the EPROM socket on the circuit board via the microprocessor. The switch on the housing is turned on to place the device in read-only mode to simulate the EPROM. Some embodiments provide the load cell 15 further comprising a MEMS. Other embodiments provide the load cell 15 further comprises nanotechnology applications comprising sensors being embedded in silicon substrate and etched/fused in a nano-fiber material configured to exhibit good electrical characteristics. Embodiments further provide the load cell 15 comprise embedded sensors being etched/fused in a microfiber material with good electrical characteristics.

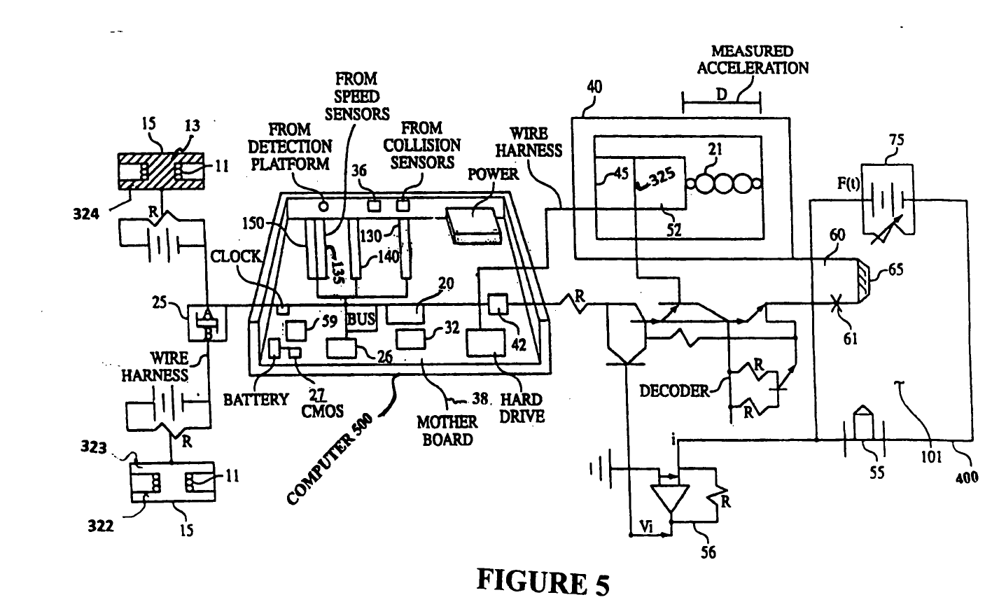

Referring to FIG. 5, embodiments provide pressure sensing device comprising a load cell 15 operatively configured with strain gauge 11. The strain gauge 11 is embedded in a silicon substrate and disposed with the seat 10 of FIG. 1. The load cell 15 is operable with initial power source R, in communication with the control module 25, via a wire harness. The load cell 15, further comprises a silicon substrate 322, being disposed with sensors 323, in communication with the computer system 500. Disclosed embodiments further provide the load cell 15, further comprises a MEMS 324. Certain embodiments provide the load cell 15 further comprises piezoresistive silicon load cell in association with the control module 25 for communications with the computer unit 500. The computer unit 500 is responsive to signals from at least one of: a detection platform, a speed sensor, and a collision sensor. The computer unit 500 further configured with a clock, a battery and/or power source, a mother board 38, CMOS 27, and a hard drive. Certain embodiments provide the post 36 being communicatively connected to the hardware in communication with the mother board 38. Some embodiments provide the computer unit 500 being operatively configured with at least one of: a seatbelt processor 140, an accelerometer processor 150, a collision sensor processor 135, and a gas canister processor 130. Embodiments further provide the computer unit 500 further comprising at lease one of: RAM 32, CPU 26, BUS 39, signal amplifier 20, gas release valve relay 42, and ROM 59.

Certain embodiments provide the computer unit 500 in communication with the accelerometer 40 via a wire harness. The accelerometer 40 comprises a spring 21, responsive to motion by at least a mass 52, in communication with crystal 45. Certain embodiments provide the accelerometer 40, being disposed with at least a coil 325, in communication with the computer unit 500. Some embodiments provide the coil 325m further comprising energy harvesting apparatus. The distance traveled by the spring 21, comprise the measured acceleration D for airbag assembly 400. Signal from the load cell 15 is further communicated to a decoder, in communication with the airbag assembly 400. Disclosed embodiments provide the load cell 15, further comprises a micromachined silicon load cell in association with at least a communication device for classifying vehicular occupants and for providing variable deployment speed for the airbag. The airbag assembly 400 is disposed with wire hardness carrying voltage from the strain gauge 11 to the current transformer 56. Disclosed embodiments further provide the airbag assembly 400 comprising a gas canister 60, a sliding pot 61, a gas igniter 55 in communication with the voltage to current transformer 56, a combustion chamber 101, and controlled gas 65.

Certain embodiments provide the load cell 15 further comprising a pressure sensing device. Some embodiments provide the computer unit 500 further responsive to signals from the collision sensor 75 in communication with the airbag assembly 400. The airbag assembly 400 being operable to release the controlled gas 65 to be ignited by the gas igniter 55, providing combustion inside the combustion chamber 101. Embodiments further provide the accelerometer 40 comprising at least one piezoelectric crystal 45 each being operatively connected to at least a mass 52. The mass 52 being communicatively connected to at least a spring 21 responsive to the energy being generated by the piezoelectric crystal 45, in communication with the sliding pot 61. The sliding pot 61 is weight responsive, and operable to allow proportionate amount of igniting gas 65 into the combustion chamber 101 for the proper operation of the airbag assembly 400.

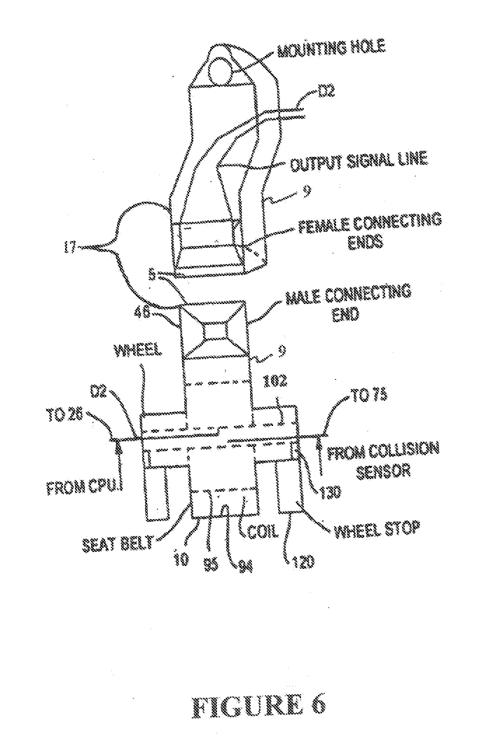

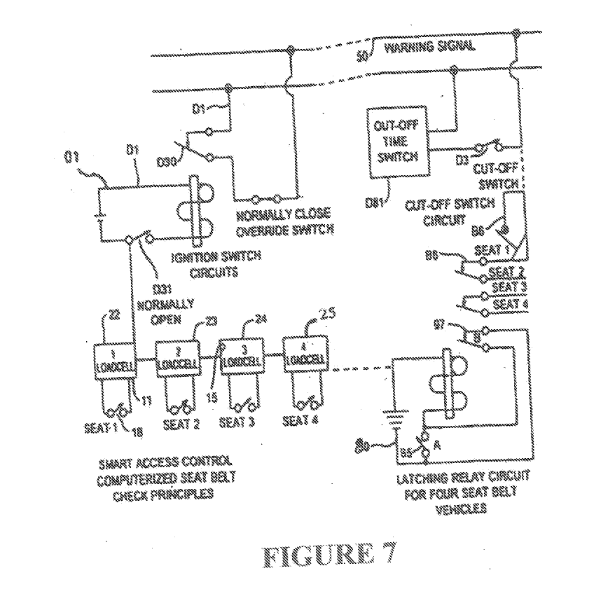

Referring to FIG. 6, embodiments further provide the restraint device comprising at least a seatbelt 17 being disposed on a seat 10 as seen on FIG. 1. The restraint device comprises a housing 9 being disposed with the seatbelt 17 in communication with a shaft 94. The seatbelt 17 comprises a mail connecting end 46, a female connecting end 5, an output harness D2 comprising output signal line, a wheel 120, and wheel stopper plunger 130. Certain embodiments provide a coil 95 coupled on the shaft 94, communicatively connected to the wheels 120. Some embodiments provide the coil 95 in communication with the collision sensor 75. The stopper plunger 130 is operable with the wheels 120. The stopper plunger 130 engages between the wheels 120 responsive to signal from the coil 95 to provide the required seatbelt tension. The coil 95 is responsive to communication signal from the processor 140 of FIG. 5. Disclosed embodiments provide the restraint device being safely secured via a mounting hole. Certain embodiments provide a restraint device in communication with the CPU 26. Some embodiments provide the CPU 26 responsive to signal communications from the collision sensor 75, in communication with the seatbelt tension sensor 600 of FIG. 1. The seatbelt tension sensor 600 is configured to adjust the tension value for the seatbelt 17 according to the collision force and weight value to protect the vehicle occupant 110 of FIG. 1 against further injury. Disclosed embodiments further provide the seatbelt tension sensor in communication with the coil 95, in association with the shaft 94, operatively configured with an electric motor 102 for converting electrical energy from the coil 95 into mechanical energy to tension the occupant.

Referring to FIG. 3 and FIG. 5, embodiments provide optoisolator 70 communicatively connected to a the computer unit 500, in communication with the seatbelt control processor 140. The computer unit 500 is further configured with a gas discharge processor 130, in communication with the accelerometer control processor 150, being operable with at least a relay comprising a gas release valve relay 42 in communication with a CPU. Certain embodiments provide the accelerometer 40 being configured with the accelerometer spring 21, the accelerometer crystals 45, and the accelerometer mass 52. The accelerometer 40 is operatively connected to the gas current igniter 55 operable for igniting controlled gas 65 into the combustion chamber 101. The collision sensor 75 is further configured with the accelerometer 40, in communication with the gas canister 60 through processors 130, 135, 140, and 150. Processor 130 is communicatively configured with gas canister 60. Processor 135 is communicatively configured with collision sensor 75. Processor 140 is communicatively configured with seatbelt tension sensor 600, as shown in FIG. 1. Processor 150 is communicatively configured with accelerometer 40. Processors 130, 135, 140, and 150 are communicatively connected to CPU 26. The reference number 65 represents the controlled release of gas 65. Some embodiments provide the controlled release gas 65 being pressured from the gas canister 60 through the opening of the sliding pot 61, into the combustion chamber 101 for ignition by the gas current igniter 55 therein, for providing a proportionate amount of deployment force of the air bags.

Referring to FIG. 7, embodiments provide a classification system comprising a latching relay circuit 30 being configured with switch B5. Switch B5 is operable for monitoring the use of seatbelt on seats 1, seat 2, seat 3, and seat 4. Embodiments provide restraint device further configured for rear sitting positions for at least one occupant, each seat being disposed with a load cell. Certain embodiments provide seat 1 configured with load cell 1, seat 2 configured with load cell 2, seat 3 configured with load cell 3 and seat 4 configured with load cell 4. Each of seats 1, 2, 3, and 4 further comprises load cells being configured with strain gauge 11. Disclosed embodiments provide apparatus for sensing weight, comprising load cells 15 being embedded in a silicon substrate 16. Certain embodiments provide the load cells being coupled to seats 1, 2, 3, and 4. Seats 1, 2, 3, and 4 are disposed with surfaces 22, 23, 24, and 25 operable for transferring loads/pressure, such as occupant's weight, to the respective load cells, comprising load cell 1, load cell 2, load cell 3, and load cell 4. Some embodiments provide switch 18 being disposed with each seat, and configured to close each time an occupant sits on each respective seats.

Other embodiments provide switch 18 further configured for providing communication signals to the seatbelt latching relay 30, being configured for checking seatbelt operation for the seat with a closed switch. Embodiments further provide switch B5 of A of the latching relay 30, being configured with switch 97 of B for enabling communication to each seatbelt device. Certain embodiments provide the seatbelt apparatus comprising a male connecting end 46 of seatbelt 17 shown in FIG. 6 connected to the female connecting end 5 shown in FIG. 6, to enable signal communications through the harness D2 to the seatbelt override switch D30. The seatbelt override switch D30 is operable with the ignition switch 01. The override switch D30 is configured with warning devices 50, operable to provide signal communications comprising warning signals when there is a load cell signal on a seat and no signal communication on the harness D2. The warning signal is visually presented to the operator of the vehicle and includes a human voice auditory response. Embodiments provide a smart seatbelt control system, comprising seatbelt monitoring apparatus being disposed with each seat. The monitoring apparatus further comprise at least a switch 18, in communication with at least a load cell and latching relay. Certain embodiments provide the seatbelt apparatus configured with switch B8, which is closed in communication with processor 140, and operable for comparing other communication signals from seat 2, seat 3, and seat 4. Each of seat 1, seat 2, seat 3, and seat 4 is further configured with switch 97 and communicatively connected to each seatbelt tension sensor of FIG. 1. Disclosed embodiments further provide at least one of: normally open switch D31, out of time switch D81, a normally closed override switch D30, and a cut off switch D3 in communication with the cut off switch circuit B6.

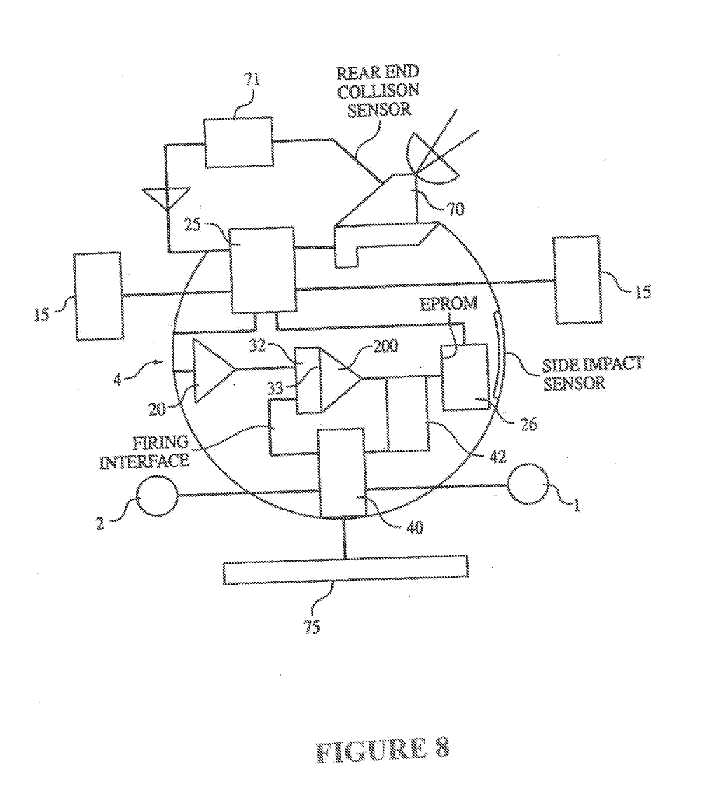

Referring to FIG. 8, embodiments provide a transient voltage suppressor 200, in communication with the address line 33. The load cell 15 is communicatively connected to the control module 25 being operable to discriminate between humanly occupied seats and unoccupied seats. The accelerometer 40 is operatively configured with an amplifier 20 operable to amplify signal communications. Collision sensor 75 is operable to detect imminent frontal collision. Radar unit 70 is operatively configured with radar receiver 71, operable for detecting imminent rear end collision. Embodiments further provide CPU 26 in communication with the accelerometer 40, being operable with the igniting gas release valve relay 42. The CPU 26 is further communicatively connected to the RAM 32, in communication with the EPROM 34. Embodiments provide a firing interface in communication with at least one of: the side impact sensor being operable with the side airbag, and airbag device 1, 2 being further responsive to signal from collision sensor 75. The amplifier 20 is further communicatively connected to transistorized switches 4.

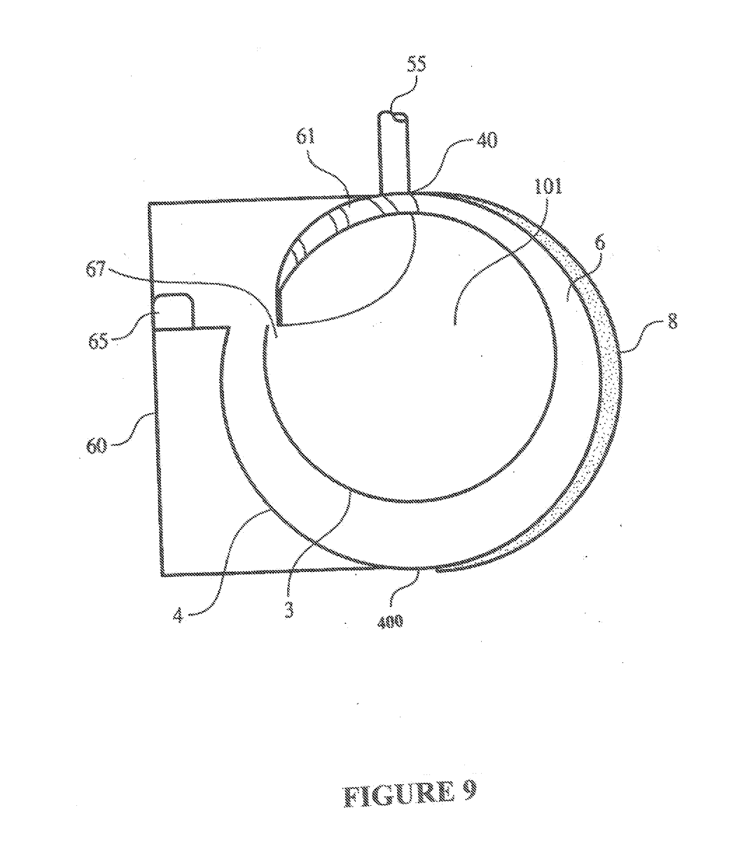

Referring to FIG. 9, embodiments provide airbag assembly 400, comprising accelerometer 40, gas canister 60, sliding pot 61, igniter 55, combustion chamber 101, and airbag sensor 8. Certain embodiments provide dual airbag comprising inner layer 3, and outer layer 4, each operable to provide extra protection for the vehicle occupant. Certain embodiments provide the inner layer 3 and the outer layer 4 being disposed for providing a cushioning effect there between, seen as gap 6. Some embodiments provide the gap 6 comprising extra cushioning to protect against deployment force impact severity. Disclosed embodiments provide at least one corresponding airbag sensor 8 disposed on the airbag device comprising at least an airbag 4. The airbag 4 is configured with at least one gas canister 60 being operable with the computer unit 500 of FIG. 5. The airbag sensor 8 is operable with the seatbelt sensor 7 of FIG. 1, and communicatively configured to direct deployment direction of each airbag away from the occupant's head. Disclosed embodiments further provide the gas canister 60 being communicatively connected to the relay comprising the gas release valve relay 42 of FIG. 5. The gas release valve relay 42 is operable for releasing controlled/measured igniting gas 65 into the combustion chamber 101 for ignition by the gas igniter 55. Certain embodiments provide the sliding pot 61 being responsive to communication signal from at least one of: the computer unit 500, the accelerometer 40, and the collision sensor 75 shown in FIG. 8. The sliding pot is operable for providing an opening 67 comprising a passage for the expansion of igniting gas 65 into the combustion chamber 101 for at least one airbag device 400. The sliding pot opening 67 is proportionate to the volume of igniting gas being released into the combustion chamber 101, and operable for providing a proportionate airbag deployment force and acceleration when the collision sensor 75 senses a collision has occurred of a severity requiring deployment of airbag 1, 2. Certain embodiment provide the computer unit 500 of FIG. 5, being responsive to the weight value and the collision severity, in communication with the airbag assembly 400 to render of sufficient tension to keep the occupant 110 of FIG. 1 on the seat 10, when a collision is sensed by the collision sensor 75 and 71, but is not rendered of sufficient tension to cause impact injury to the occupant 110.

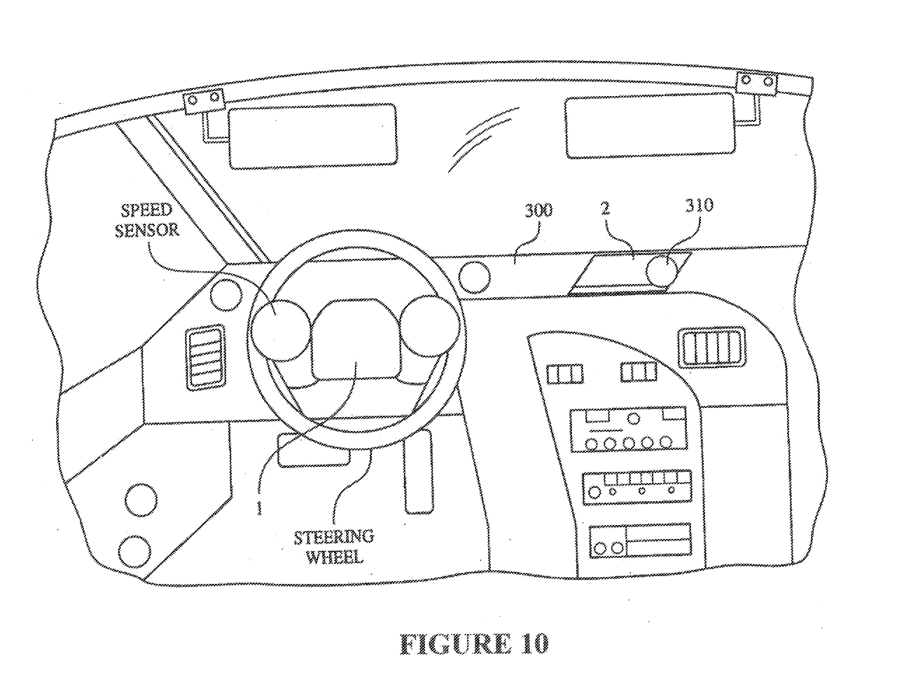

Referring to FIG. 10, embodiments provide a vehicle interior, comprising a dashboard 300, being disposed with pressure sensor 310, airbag device 1, and airbag device 2. Airbag device 1 is disposed on the steering wheel operable for protecting the operator of the vehicle. Airbag device 2 is disposed on the dashboard 300 and operable for protecting the vehicle occupant 110 of FIG. 1, who may be at least one of the passengers in a vehicle. The pressure sensor 310 is operatively configured for sensing objects being disposed on the dashboard 300, such as the leg of a human body. Embodiments further provide the pressure sensor 310 in communication with the commuter unit, and operable to adjust the deployment strength of a restraint device in compensation for the detection of any human body parts on the dashboard.

Referring to FIG. 5 and FIG. 8, the accelerometer 40 is configured with the amplifier 20, providing line signals to the gas canister sliding pot 61, which is operable to provide an opening 67 for the passage of controlled volume of gas 65 into the combustion chamber 101. The sliding pot opening 67, is further configured with the gas release valve relay 42, operable to release the controlled gas 65 into the combustion chamber 101 for ignition. The controlled release of gas 65 is ignited by the gas current igniter 55, to deploy the air bag intelligently upon ignition, with a force that is proportionate to the weight of the sitting occupant 110. The energy generated by the accelerometer crystals 45 displaces the accelerometer mass 52 in the accelerometer 40, to generate a corresponding amount of electrical energy. Disclosed embodiments provide the accelerometer 40 comprising at least a piezoelectric accelerometer. Certain embodiments provide a ROM 59 and BIOS, a RAM 32, and software program in communication with the load cell 15 being operable for providing information about the weight of the sitting occupant 110. The BIOS is further configured to provide basic control over the load cell 15 and is stored in the ROM 59.

The ROM 59, which is a special chip, contains instructions and information in its memory that can not be changed, whereas the RAM 32 is the primary memory storage for storing the occupant 110 information. The accelerometer 40 normally generates electrical energy when put under mechanical stress. Applying pressure on the surface of the accelerometer crystal 45 creates the measured stress comprising the measured acceleration D. Certain embodiments provide the measured acceleration D being initiated by the applied weight on the seat 10. Disclosed embodiments further provide accelerometer that converts the measured acceleration corresponding to the weight of the occupant 110 into an acceleration value corresponding to the proper amount of acceleration at which the air bag 1, 2 would have to be deployed to protect the occupant 110 in the event of a collision.

The electrical energy being generated by the accelerometer crystal 45 would displace the accelerometer mass 52 in the accelerometer 40, and the displacement force will react on the accelerometer spring 21, and compressing the spring to an amount proportionate to the occupant 110 applied weights on seat 10. The force exerted on the accelerometer spring 21 is proportionate to the weight of the occupant 110. Disclosed embodiments further provide apparatus for sensing collision. Certain embodiments provide a collision sensor 75 shown in FIG. 8, in communication with the control module 25, being configured with the amplifier 20. The amplifier 20 is further configured to amplify the signal from the load cell 15, to the accelerometer microprocessor 150, in communication with and the release gas control processor 130, which is configured with the gas release valve relay 42. The control module 25 is communicatively connected to the gas current igniter 55, operable to ignite the controlled release of gas 65, inside the combustion chamber 101 for the air bag 1, 2. The force created during the combustion inside the combustion chamber 101, is the deployment force for the air bag 1, 2.

The speed of the vehicle and the collision threshold determines the crash severity and allow the seatbelt 17 to lock the occupants 110 in place while the deployment of the air bag 1, 2 protects the occupant's upper body from moving. The load cell 15 differentiates adults from kids with the highest degree of reliability. Occupants 110 are differentiated from objects through temperature sensor 18. The occupants 110 weight on the surface of the seat 10 and the occupants 110 weight on the floor 100 are transmitted to the load cell 15 to equal the occupant's input or total weight. The weight information is kept constant at the address line 33, so that even if the occupant 110 moves around the seat 10, the weight information at the address line 33 will not change. But when the occupant 110 finally leaves the seat 10, the erasable programmable read only memory-EPROM 34 will erase the occupant's 110 weight information from the address line 33. That is, when a new occupant 110 is seated, new information will be sent to the address line 33. Accordingly, the parameter of weight for the air bag to enable airbag deployment is precisely determined. Disclosed embodiments provide erasable programmable read only memory in communication with a memory apparatus and operable for monitoring occupants sitting positions and occupants movements.

Referring back to FIG. 6 further denotes a seatbelt comprising connecting ends configured with a wiring harness, which is communicatively connected to a coil. Disclosed embodiments further provide the harness in further communication with the latching relay circuit as shown in FIG. 7. The embodiments further provide apparatus configured to check for the occupied seat and the seatbelt latch for that occupied seat.

Referring to FIG. 8 further denotes an exemplary embodiment of a rear end collision comprising a radar unit 70 operable to sense the imminence of a rear impact. The data from the rear end collision is communicated to control module 25, further operable to control detection data of occupants 110 on seats 10 to enable effective deployment of air bag 1, 2. In a frontal impact of about 13.2 MPH, collision sensor 75 is activated. The speed of 13.2 MPH represents the threshold speed at which the efficacy of any air bag system should usually become activated. At collisions of below the 13.2MPH, the air bag system tends to become less effective and expensive to deploy. Disclosed embodiments provide collision sensor 75 configured with airbag assembly operable to detect frontal and rear impact is of an extremely low speed. The preferred embodiment of the present invention would not deploy airbag 1, 2 until an occupant 110 is detected and the front impact of speed about 13.2MPH and above is achieved. Thus, if the collision force is greater than the force normally created by a speed of about 13.2MPH, airbag assembly 400 would be responsive because the on-coming vehicle may have been driving at speed above 13.2 MPH, creating a varying force which may enforce further injury. With the present invention, airbag assembly 400 is responsive to the speed of the vehicle, the occupants 110 weight, and the collision force during impact. The data stored in address line 33 is used for airbag calibration, and the air bag 1, 2 is operable to deploy with the proper volume of propellant 65.

Referring to FIG. 9, reference number 65 represent the controlled release of gas 65. The reference number 67 represent an opening of the gas canister 60 for the controlled release of gas 65 to be released into the combustion chamber 101. Certain embodiments provide the controlled release of gas 65 is being pressured from the gas canister 60 through the opening 67, of the sliding pot 61, for the releasing of the controlled gas 65, into the combustion chamber 101 to be ignited by the gas current igniter 55 therein, initiating a proportionate amount of airbag deployment force of for at least first air bag assembly 400. In the illustration of FIG. 9, air bag assembly 400 has two layers 3, 4, operable to further minimize the impact of airbag deployment. An internal layer 3 is the base of the air bag 1, 2 shown in FIG. 8, which is configured to be deployed with the external layer 4, forming a cushioning there-between. The external layer 4 is the cushion layer characterized by being foamy. There is a gap 6 between the two layers 3, 4 being provided for providing a cushion-like contact on occupant 110 shown in FIG. 1. The weight of the occupant 110 is correlated into an expected impact force and the desired amount of propellant or controlled release gas 65 for the air bag 1, 2 is ignited to provide the cushioning which balances this force, but does not over power occupant 110 or force occupant backward into seat 10 at such rate as to cause injury. The greater the volume of propellant or controlled release gas 65 for the air bag 1, 2, the smaller the gap between the two air bag layers 3, 4 upon airbag deployment associated with the controlled energy. Thus, the two-layer air bag 1, 2 serves to maximize protection and prevent further injury for occupant 110. Disclosed embodiments provide airbag assembly 400 further comprising a two stage airbag operable to provide extra cushioning against the body of occupant 110 to prevent further bodily injury.

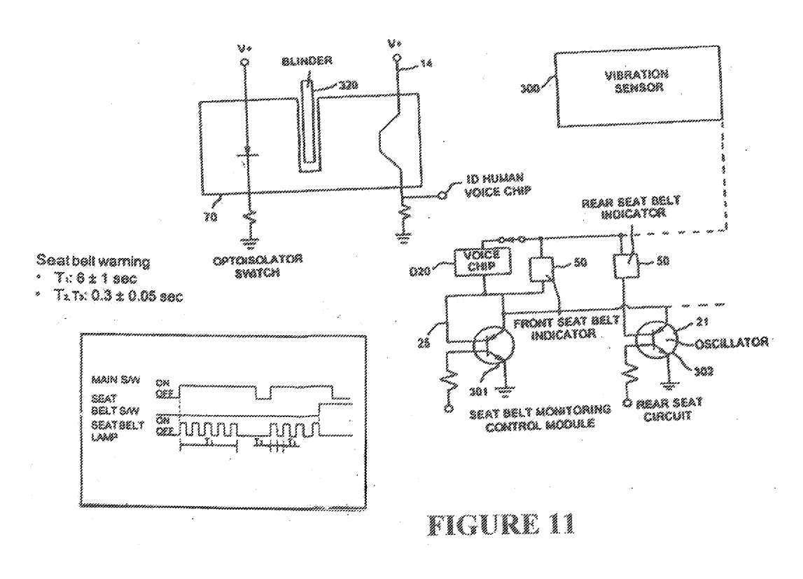

FIG. 10 denotes the interior of a vehicle configured with airbag 1, 2 and a pressure sensor 320 in communication with computer unit 500. Referring to FIG. 11, embodiments further provide optoisolator switch 70 configured with a seatbelt monitoring control module 301. Disclosed embodiments further provide seatbelt apparatus comprising an out of time switch, an override switch and other switches configured to expedite communications. The seatbelt monitoring control module is in communication with the optoisolator switch 70, and comprising a time critical switch T1, T2, T3 operable to provide warning to the occupants when the seatbelt apparatus is not buckled. At least a lamp is configured with the switches for activation when the seatbelt is not buckled or the switch 18 in off position. The lamp is further disabled when the seatbelts are buckled or switch 18 in on position. Embodiments further provide a vibration sensor 300, a voltage output V+, at least an ID harness coupled to human voice chip 020. The human voice chip 020 is configured with the rear seatbelt indicator 50 and the front seatbelt indicator 50. Each of the front seatbelt indicator 50 and the rear seatbelt indicator 50 is communicatively connected to the front seatbelt monitoring control module 301 and the rear seatbelt monitoring control module 302 respectively. The front seatbelt monitoring control module 301 and the rear seatbelt monitoring control module 302 are configured with the weight classification control module 25, in communication with an oscillator 21 responsive to warning signals when an occupant 110 is unbelted.

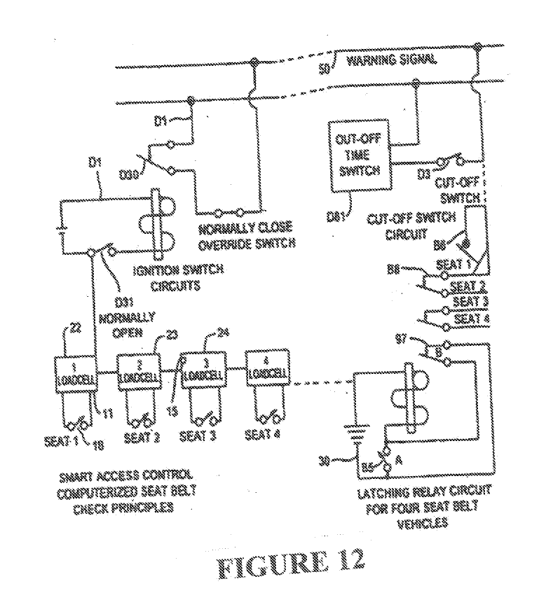

Referring to FIG. 12, embodiments provide a smart access comprising apparatus for controlling the operation of the seatbelt system. The smart access comprising a latching relay 80 configured with a cut-off switch and in communication with the seatbelt monitoring control module of FIG. 11. Certain embodiments provide a classification system comprising the latching relay circuit 30 being operable with switch B5, Signal communication from B5 is provided for monitoring the use of seatbelt 17 on seats 1, seat 2, seat 3, and seat 4 configured for each seat. Embodiments provide rear sitting positions for four occupants 110, comprising seat 1 in association with load cell 1, seat 2 configured with load cell 2, seat 3 configured with load cell 3, and seat 4 configured with load cell 4. Each of seats 1, 2, 3, and 4 further comprises the load cells being configured with silicon substrate, and strain gauge 11 being embedded in the silicon substrate 16. Certain embodiments provide seat surfaces 22, 23, 24, and 25 being operable with load cell 1, load cell 2, load cell 3, and load cell 4 to detect pressure from occupants 110. Switch 18 is configured for each seat, and being operable to close when an occupant 110 is detected. Some embodiments provide communication signals to the seatbelt latching relay 30, being operable to check for seatbelt operation for the detected seat containing the pressure signal. Embodiments further provide switch B5 of A of the latching relay 30, being configured with switch 97 of B for enabling communication to each seatbelt 17. When the male connecting end 46 of seatbelt 17 shown in FIG. 1 is connected to the female connecting end 5, signal is communicated through the harness D2 to the seatbelt override switch D30, being operable with the ignition switch 01. Communication signals are visually presented to the operator of the vehicle, and may be broadcasted in human voice auditory via warning device 50. When seatbelt 17 is buckled for seat 1, switch 18 of seat 1 would be closed. Switch B8 is also closed in communication with processor 140 to compare other communication signals from seat 2, seat 3, and seat 4. Each of seat 1, seat 2, seat3, and seat 4 are configured with switch 97, and communicatively connected to each seatbelt 17 being assigned for each seat 10. Disclosed embodiments further provide at least one of: cutoff switch, normally open switch D31, out of time switch D81, a normally closed override switch D30, and a cut off switch D3 in communication with the cut off switch circuit B6.

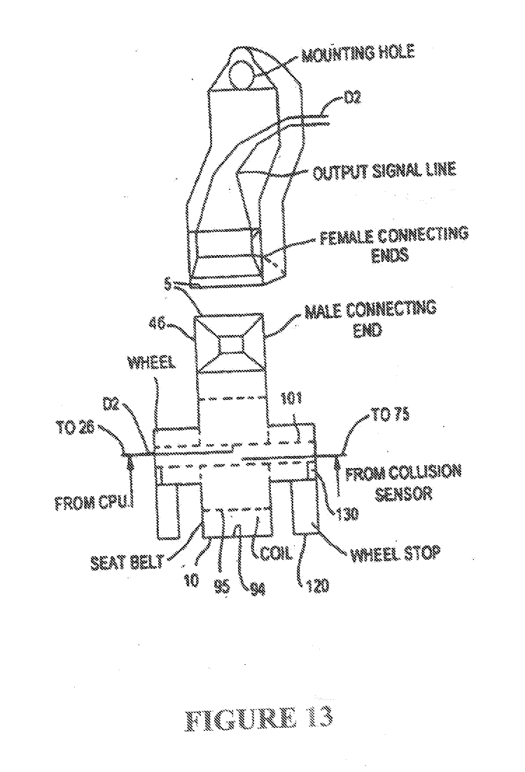

Referring to FIG. 13, is seen an exemplary embodiment of a restraint device comprising the seatbelt 17 being disposed on a seat 10. The restraint device further comprises a housing being disposed with the seatbelt 17. The seatbelt 17 is disposed on a shaft 94, and comprises male connecting end 46, a female connecting end 5, an output harness D2, a wheel 120, and wheel stopper plunger 130. Certain embodiments provide a coil 95 comprising at least an apparatus for regulating tension to the seatbelt. The coil 95 is mounted on a shaft 94, which is communicatively connected to wheels 120. Some embodiments provide the coil 95 in communication with the collision sensor 75. The stopper plunger 130 is operable with the wheels 120. The stopper plunger 130 engages between the wheels 120 in response to signal communications from the coil 95. The coil 95 is further responsive to communication signals from the processor 140 to rotate according the at least one of: the occupant's weight; the vehicle speed; the collision force according to the vehicle speed. Disclosed embodiments provide the restraint device being safely secured via a mounting hole. Certain embodiments provide the CPU 26 responsive to signal from the collision sensor 75, in communication with the coil 95. Some embodiments provide a seatbelt apparatus configured with an electric motor 102 in communication with the coil 95 for regulating seatbelt tension. Other embodiments provide the electric motor 102 operable with the coil 95 for converting electrical energy into mechanical energy. The mechanical energy provide rotation of the wheels 120 to regulate tension on the seatbelt 17, in the amount proportionate to the collision force and the weight of the occupant 110 on seat 10. Other embodiments provide Seatbelt 17 being configured with the moveable coil 95 operable for tensioning occupant 110 per the rotation of wheel 120 based on at least weight.

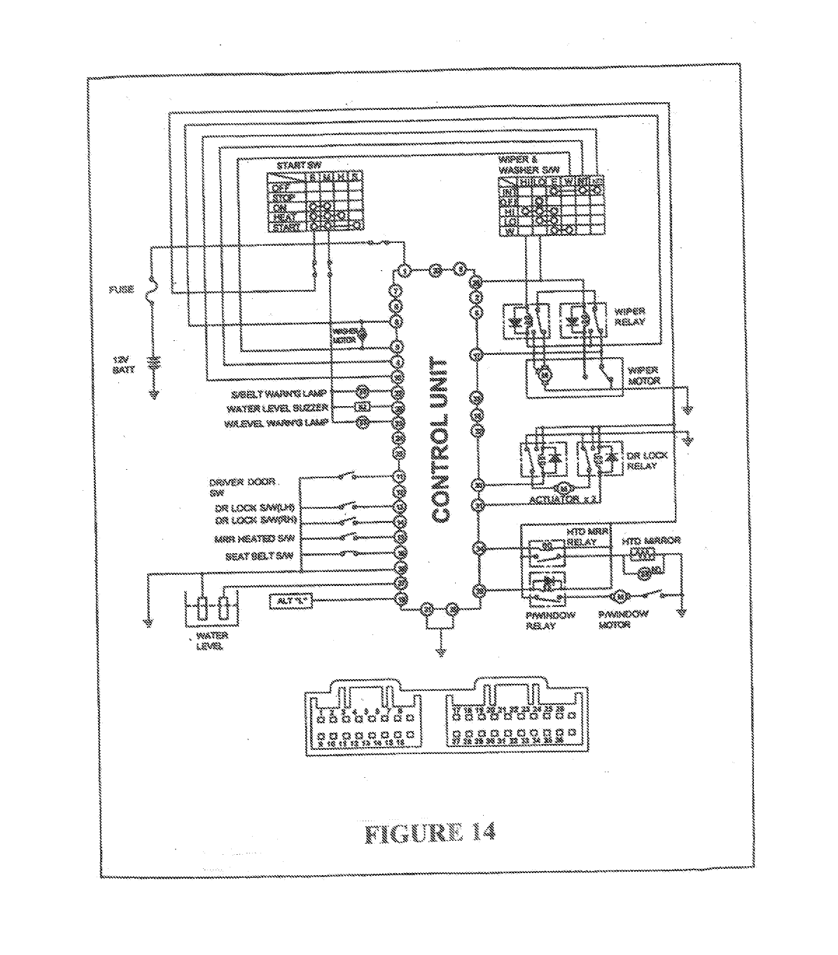

Referring to FIG. 14, embodiments provide a control module comprising a control unit operable for controlling the windshield wiper/washer, the engine electronics, the door lock and window up/down, such that when occupant 110 leaves seat 10 and the ignition key is taken off and at least a window is lowered down, the control module, upon realizing that there is no occupant 110 on seat 10, will automatically enable the power window relay and the power window motor would then raise the window up. In other embodiment of the present invention, if occupant 110 is on seat 10 and the ignition key is turned off and the windows locked, the control module would communicate to the power window relay and the power window motor would then lower the windows or turn on in-vehicle HVAC to allow ventilation to occupant 110. Disclosed embodiment provide a control module configured to control a start switch, a wiper and washer switch, a wiper motor, a wiper relay, a seatbelt warning lamp, a water level buzzer, a water level warning lamp, a driver's door switch, door lock switches, mirror heated switch, seatbelt switch, door lock relay, door actuator, heated mirror relay, window relay, and window motor.

With reference to figures, FIG. 1, seat cushion 12 and floor 100 are shown respectively. Seat 10 is mounted on a load cell 15, which is disposed between the seat mounting frame 16 and floor 100 of the vehicle. The load cell 15 ascertains the weight of the seat 10 and the occupant 110 therein. A temperature sensor 18 is configured with the load cell 15 for distinguishing between occupant's 110 and any conventional luggage. Insight line angle configuration includes photocell shown in FIGS. 2 and 3, temperature sensor 18 is position close to the feet, which comprises the leg angle of occupant 110. The temperature sensor further comprises conventional infrared sensor configured to sense occupants 110 body temperatures.

Referring to FIG. 5, the energy generated by the accelerometer crystals 45 displaces the accelerometer mass 52 in the accelerometer 40, to generate a corresponding amount of electrical energy there from, such as might occur if accelerometer 40 is piezoelectric accelerometer. Disclosed embodiments further provide in vehicle information about occupant 110. By incorporating a ROM 59 and BIOS, a RAM 32, and software program in communication with the load cell 15, embodiments is configured to provide information about the weight of occupant 110. The BIOS provide basic control over the load cell 15 and is stored in the ROM 59. The ROM 59, which is a special chip, contains instructions and information in its memory that can not be changed, whereas the RAM 32 is a primary memory storage medium configured for storing the occupant 110 information.

Disclosed embodiments provide standard configuration for an occupant 110 and driver's side seatbelts 17, all configured in the same manner. FIG. 5 further denote a classification system for the occupants. When the ignition switch is turn on, electrical current of 5 milivolt energizes the load cell 15, which is configured with the computer unit 500. When an occupant 110 seen on FIG. 1 takes on any of the seats 10, the load cell 15 would be in communication with the computer device memory 32 to enable data processing and computation. The post 36 inside the computer checks all the hardware components functionality to ensure that the hardware components configured with the CPU 26 are functioning properly. The post 36 later sends signals over specific paths on the chip motherboard 38 to the load cell 15 to account for the weight signals or responses, to determine the occupant's actual weight value. The input from the occupant's body when seated is received as force energy.

The load cell 15 is configured to provide electrical output as weight value to the control module 25, and the oscillator 21 will oscillate, indicative of signal received, enabling the control module to identify the seat 10 that has the occupant 110. The control module distinguishes front seat occupants from rear seat occupants through the front seat circuit 301 and the rear seat circuit 302. The chip motherboard 38 is where all activities are sent for processing. The result of the post reading is then compared with, in the CMOS 27 to enable accurate and timely responses to signal communication. At the completion of the post 36 readings, the boot program 08 will then check if there is any occupant 110 on any of the seat 10. The boot program would then send the occupant's information on weight to the address line 33 to avoid interference from vibrations and lightening current or thunderstorm. The CMOS is a memory where all P.C and hard drive configuration are stored, and also keeps track of the time and date of all information stored for the control of the seatbelt system.

The post 36 is configured to send signals over specific paths on the motherboard 38 to the load cell 15 to check for the presence of the occupants 110 on all the occupied seats 10. The motherboard 38, further comprises a chip where all the occupant's activities are sent for processing. The motherboard further provides information from the post 36 to be compared with the information in the CMOS before processing. After all signals are processed, the boot program 08 will send the occupant's information to the address line 33 for storage. When the driver takes the driver's seat 22, the strain gauges 11 would provide electrical responses from the applied bending, stretching, or compressing of the load cell 15. These electrical responses are then communicated to the computer unit 500, to enable communication signal to switch 18 on seat 1 22. By closing the circuit on seat 1 22, the ignition switch circuit would then be energized so that the engine would be started.

Disclosed embodiments provide a switch apparatus 18 further operable for turning on the optoisolator switch 70, in communication with the latching relay 80, to ensure that all the occupants are belted. If any of the occupant 110 is not belted, the isolator switch will then send a “1” signal comprising signal communication to the seatbelt processor 140 to enable the control module 25 to activate the human voice chip 020 to warn of the unbelted occupant 110. If the occupant 110 is still not belted, the cutoff switch 03 would be enabled to shut off the engine after 5 seconds time lapses. The counter 50 is operable with the latching relay 80 and the optoisolator switch 70 to check out all the other seats by tracking the number of occupants 110 that are present. Certain embodiments provide the Spring Control 20 for the Isolator Switch of FIG. 3, being configured to deploy a spring carrying current 40 for monitoring the contacts of each seatbelt connectors 5. When the current is restricted or cutoff, the spring will retract to unlock the seatbelt connectors inside the open fixed end of the seatbelt housing shown in FIG. 6.

Disclosed embodiment further provide the cutoff switch circuit 03 operable in closed position to allow the control module 25 in the energized state. When any occupant 110 is not wearing the seatbelt 17, the counter circuit 50, and the latching circuit 80 would be closed for that seat location, enabling the blinder 321 to disengage, allowing the cutoff switch 03 to stay opened for the engine to shut off. When the vehicle rolls over in a roll over type accidents, the vibration sensor 300 shown in FIG. 11, would sense the roll over activities and activate the cutoff switch 03. The cutoff switch 03 would enable the tensional moveable coil 95 in communication with the motor 102, to motion the seatbelt 17 to and hold the occupant secured on the seat 10 prior to the flip. The vibration sensor 300 and all other initial sensors are programmed to respond to a delay, allowing the cutoff switch 03 to be activated at the end of the delayed intervals.

Certain embodiments provide a power line transient 310 that ensures the protection of any failure that may occur within the computer and the electronics due to external voltages. The power line transients 310 are operable to filter out lightening effects or transient phenomenon from the computerized or electronic system so that the precise and accurate transmission of the occupant's weight information is guaranteed. When an occupant 110 sits on any of the seats 10, the load cell switch 18 will close, allowing the load cell output energy to energize the control module 25. The control module 25 is further configured with the counter 50, operable to count the number of closed load cell switches 18. Some embodiments provide the control module 25 configured with the optoisolator switch 70, in communication with the latching relay 80 to check for the seatbelt latching of the occupied seats 10 with closed load cell switches 18 to assure occupants safety.

When switch 18 for the occupied seat 10 is closed, the latching relay 80 circuit will also be energized so that the seatbelt 17 for the occupied seat location is checked for buckling. The latching relay 80 circuit and the counter 50 circuit are closed only when an occupant 110 takes any of the seats 10. The energizing of the latching relay 80 is momentary, and each time the latching relay 80 is energized, switch “A” is closed. Once the latching relay 80 is energized, contacts “B” will close, holding the latching relay 80 in the energized state after switch “A” is opened. All the other contacts 87 97 will follow the same sequence of operation shown in FIG. 7. The seatbelt 17 and the latching relay 80 are arranged so that the contacts of seat 1 of 22, which is the driver's seat, will supply power to the coils of seat 2-23, seat 3-24, and seat 4-25.

Other devices may be used in place of the load cell, like a pressurized or inflatable bag that would be mounted on the surface of the seat or beneath the seat. When an occupant takes the seat, the occupant's weight will displace x-amount of the stored pressure to a relay that will record the displacement as weight. The stored pressure is the maximum pressure to support the weight value of the occupant. The weight of the replacing occupant will displace the stored pressure to the amount equal to the occupant's weight value. If the weight of the occupant exceeds or equal the stored value, then the tensional force on the seatbelt against the occupant would have a constant value. The recorded displacement will then be transformed into a weight value unit that the CPU will recognize. The CPU is configured to carry on the computation and calculation of the displacement pressure the same way like the load cell. Every process is the same when comparing the pressurized bag operation with the load cell operation. Therefore, for more accurate readings of the occupant's weight, only the load cell will be described in the entire description. However, the applicant is claiming the use of any bag to control the operation of the seatbelt.

Disclosed embodiments further provide the load cells 15 being mounted underneath the seat 10 and bolted between the mounting metal base of the seats 10, and the floor 100 of the vehicle. Said mounting location of the load cells provides a solid support and attaching structural strength for maintaining precise and accurate loading of the occupant's weight on the load cells. The load cell 15 ascertains the weight of the passenger's seat 10 and any occupants' 110 therein. The load cell 15 can also be calibrated so that the weight of the seat 10 is the zero point reading.

Mounting the load cell 15 between the mounting metal base of the seat 10 and the floor 100 of the vehicle, or on rigid sliding or fixed surfaces, rather than within the passenger's seat 10, the present invention is more likely to obtain an accurate computation of the passenger's weight. The weight is not subjected to any faulty readings normally caused by the nature and configuration of the cushioning 12 between the thickness of the contact sitting surfaces 13 of the passenger's seat 10 and the occupant 110 movement. The load cell 15 comprises a weighing system that provide is a high accuracy scale, and is further configured with an in vehicle information system. Disclosed embodiments provide a high accuracy weighing system operable to provide in vehicle information about the occupant 110. Incorporating a ROM or BIOS memory 59, a RAM memory 32, and software program inside the load cell 15, further provides apparatus configured to record any and all the information about the changing occupant 110. The BIOS provides basic control over the load cell 15 and is stored in the ROM 59. The ROM 59, which is a special chip for the computer device, contains instructions and information in its memory that is not changeable. Whereas the RAM 32 further comprises the address line 33, comprising is a primary storage for occupants' weight information.

Certain embodiments provide the memory 32, further operable to record all the necessary computed weights and also feed the CPU 26 with the information to allow calculation of the tensional force and other necessary information needed for the control of a variable tensional force for the seatbelt 17. The tensioning of the seatbelts 17 generates a force proportionate to the computed weight of the occupant 110 on the sensed seat 10.—When the key switch 01 is turned on, RAM 32 is a blank slate. The memories are filled with 0s and 1s that are read from the load cell output to the address line. When there is no occupant on the seat, every data in RAM 32 will disappear. The software 16, will recognize each data lines outputting the pulses-signal, and interprets each pulse as a 1. Any line on which a pulse is not sent is represented as a 0. The combination of 1s and 0s from eight data lines will form a byte of data. Disclosed embodiments further provide the RAM 32 being operable as a collection of transistorized switches comprising the control room as shown in FIG. 8. The 1 and 0 is an ON and OFF switch used to control data in the binary number system.

Some embodiments provide the load cell 15 comprising of corrosion resistant high alloy steel configured for operation with a dynamic load cell capacity of up to 1000 lb or more. Other embodiments provide the load cell 15 comprising machined high steel beams configured with strain gauges 11 bonded inside. The load cell 15 is disposed in vehicles with seatbelts 17 or any restraint system like the air bags 1, 2. The strain gauges 11 are electrical resistance elements, and are properly sealed with sealant that will not allow moisture or any contaminant to disrupt the strained information.

Disclosed embodiments further provide the control module 25 comprising of silicon-controlled rectifier, which receives pulses at the gate 29 from the load cells 15. These pulses are currents that are transmitted to energize other devices, like the cutoff switch 03, to shut off the engine when an unbelted occupant 110 is detected. Certain embodiments provide the silicon-controlled rectifier comprising electrical isolation device configured to provide logical operations, further monitors the seatbelt latches 5 shown in FIG. 1 FIG. 5, and FIG. 12. When the seatbelt 17 is latched, or the first voltage zero is received, the control module 25 will turn on the magnetic cylinder 60 shown in FIG. 3. When the first current zero is received or the ignition switch 03 turned off, the control module 25 will turn off the magnetic cylinder 60. The control module 25 is configured with the seatbelt processor 140 in communication with the computer unit. When the occupant 110 is belted, the control module 25 would allow current to flow that will draw the magnetic poles for the magnetic cylinder 60 together to keep the seatbelts locked while the vehicle is in motion.

Referring further to FIG. 3, the optoisolator switch 70 is in communication with the seatbelt 17 of FIG. 1. When the seatbelt 17 is latched, a phototransistor 73 and the LED 74 will face each other across the open slit 71, of the optoisolator switch 70. The optoisolator switch 70, is an optical coupler, and depends on the input of the LED 74, to optically be coupled to the photocell 73. When an occupant 110 is not belted, the LED 74 will be off, a “0” signal and the photocell 73 resistance will then be high. When the occupant 110 is belted, the LED 74 current will be on, a “1” signal and the photocell 73 resistance will then be low. The interface module 200 for the photocell 73 will measure the light intensity inside the optoisolator 70 for all two faces of the photocell and allow activation of the op-amp 35. The op-amp 35, which is a signal interface between the photocell 73 and the latching relay 80, will then amplify the latching relay 80, to compare the buckling signal and the unbuckling signal at the LED 74. The photocell 73 further comprises a sensor or a transducer, operable for converting light or optical energy into electrical energy to further monitor the motion of the seatbelt 17.

When the seatbelt 17 is latched, the arrangement of the electrically conducting wires for the optoisolator circuit 70, to the magnetic cylinder 60, will initiate a lock at the contact points of the seatbelt connectors. This lock is for preventing occupants 110 from disconnecting the seatbelt 17 when the vehicle is in motion. When the seatbelts 17 are connected, the metal connectors 46 on the mobile end of the seatbelt 17 will trigger the circuit for the magnetic cylinder 60 to keep both ends locked while the vehicle is in motion. The input voltage 14, for the optoisolator circuit 70, is configured to control the flow of current. The optoisolator 70 monitors and compares this flow to the resultant current that leaves the circuit to achieve the impedance matching for each seat. This impedance matching will help the occupant sitting position counter 50, to assist the seatbelt processor 140 in knowing the number of occupants 110 that are in the vehicle and would also help to identify the seat location for the unbelted occupant 110. The counter 50 will also check the operation of any other devices and switches. If any malfunction switch is detected, the voice chip 50 will activates a user-defined message to be broadcasted to the driver for possible follow-ups and repairs. Signals are transmitted in digital and amplified by the op-amp 35 to provide timely responses.

The tensioning of the seatbelt 17 and the airbag deployment force are controlled by the occupant's presence and the body weight. The table below shows occupants weight values in decimals as they are converted to binaries at a constant speed of 13 MPH that will enable deployment of the air bag and provide variable deployment force and effective seatbelt tensioning of the occupants. The table also shows that kids and adult passengers are all protected in with the present invention. An example of the binaries is shown below, representing “ON” and “OFF” switches in “0s” and “1s”.

WEIGHTS IN DECIMALS & BINARIES

| | | SPEED |
|---|---|---|
| | “Off & on switches” | “Minimum speed for deployment” |
| DECIMAL | BINARY | MINIMUM SPEED |
| 1 | 1 | 13 MPH |
| 2 | 10 | 13 MPH |
| 3 | 11 | 13 MPH |
| 4 | 100 | 13 MPH |
| 5 | 101 | 13 MPH |
| 6 | 110 | 13 MPH |
| 7 | 111 | 13 MPH |
| 8 | 1000 | 13 MPH |
| 9 | 1001 | 13 MPH |
| 10 | 1010 | 13 MPH |

The On and Off switching sequence may include defined weight limits per
vehicle make and model, selected by vehicle manufacturers or suppliers
to the manufacturers, but not limited to;

| | | |
|---|---|---|
| 450 | 111000010 | 13 MPH |
| 451 | 111000011 | 13 MPH |
| 452 | 111000100 | 13 MPH |
| 453 | 111000101 | 13 MPH |
| 454 | 111000110 | 13 MPH |
| 455 | 111000111 | 13 MPH |
| 456 | 111001000 | 13 MPH |
| 457 | 111001001 | 13 MPH |
| 458 | 111001010 | 13 MPH |
| 459 | 111001011 | 13 MPH |
| 460 | 111001100 | 13 MPH |

The computerized switches as shown above to represent the occupant's weights are computed from a weight range of one pound to a weight range of four hundred and sixty pounds. Each measured weight is programmed to turn on and off combinations of switches representing the occupants' various weights. Referring to FIGS. 1, 3, 5, and 12 further provide a monitoring and control device for seatbelt and airbag operations. When the override switch 06 is pushed in, current will be restricted from flowing through the optoisolator switch 70. This restriction to current flow will allow the occupant 110 to unlatch the seatbelt 17 when desired. Additionally, with the closed circuit, current will run through the device of the present invention and the seatbelt 17 will stay locked. When the circuit is opened, the sensors will be in parallel until the occupant 110 latches the seatbelt 17, enabling the circuit to then be closed.

By closing the circuit for the override switch 06 will allow current to flow to the transistorized switches 04, activating the control module 25 with a “1” signal so that the module 25, will discontinue signal communication to the cut off switch 03. The ignition switch 01 is arranged to ensure that, one set of contact for the ignition switch 01, is assigned to each seat 10 in the vehicle. So that each time an occupant 110 takes any of the seats 10, one set of contact 030 will be closed for the air bag and the other set of contact 031 would be opened for the seatbelt 17. When the occupant 110 latches the seatbelt 17, the contact for said seatbelt 17 would then be closed, enabling the blinder 321 to be set in the slit 72, providing a closed slit 72. The seatbelt circuit to stay open is an indication that the occupant 110 is not belted and the unbelted behavior will prevent the driver from starting the vehicle. If the driver decides to get in the vehicle only to buckle up and start the vehicle, when the driver leaves the vehicle idling, the engine would cutoff 5-minutes later.

The control module 25 enables the cutoff switch 03. This cutoff switch 03 will be in a standby mode for about 5 minutes, which is adjustable, until the human voice response is enabled, the cutoff switch will shut off the engine if the occupant is still not belted. Additionally, if the occupant decides to buckle up during the broadcasting sequence, the latching relay 80 would stay in communication for that seat and the control module 25 would switch back to normal mode. All signals are transmitted electronically in binaries, by means of the transistorize switches 04 turning different switching signals on and off in “0s” and “1s”. Other elements of this invention also transmit signals electronically. When the occupants 110 initially take the seats 10, all the loaded load cells signals will be in analog.

The analog signals will then be converted to digital, which are compared to the preset signals to assure of the analog to digital signal transformation. The digital signals will correspond to the difference in the presence or absence of the occupant 110 on the seat 17, and the seatbelt location. The digital signal is then compared to the actual current level at each point on the seat pattern and the preset current level to confirm the presence and buckling of the occupants 110. When the seatbelts 17 are latched, a phototransistor 73 and light emitting diode “LED 74” will face each other across an open slit 71 of the optoisolator circuit 70. The diode 74 is energized when the occupant 110 is belted, enabling the applied voltage to provide a forward bias. The control module 25 will also prevent the transients or voltage spikes on both the source and the load. The seatbelt latching circuit for the present invention measures light intensity from the load cell 15 as a signal indicative of an occupant presence and allow the op-amp 35 to process the signal interface between the optoisolator 70 and the latching circuit 80. The op-amp 35 is further configured to compare the light emitting diode “LED 74” when the load cell circuits are closed. When the seatbelts 17 are connected, the blinder 321 will kick out of the slit 71 and the magnetic cylinder 60 will then be energized. The seatbelt 17 is communicatively connected to a seatbelt control sensor 600 shown in FIG. 1.

No matter how involved the police and the government get in the matter of seatbelt usage, occasionally people still forget to protect their own lives. Accordingly, disclosed embodiments provide a seatbelt control system operable to avoid negligence and to automatically protect every occupant in any automobile. The smart seatbelt control system is operable to reduce fatalities when an accident does occur. “Buckle-up, it is a law and the best thing to do.”

It is now understood that the present invention is not limited to the sole embodiment described above, but encompasses any and all embodiment within the scope of the claims. While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood therefore, that the scope of the present invention is not limited to the above description, but encompasses the following claims;

What is claimed:

1. Advanced vehicle occupant seat detection and weight responsive classification system; comprising:
at least one seat each configured with at least a seat mounting structure;
at least one weight sensing unit operatively secured between said seat mounting structure and the floor of the vehicle;
at least one supplemental restraint system;
at least one computerized system communicatively connecting said at least one weight sensing unit to said supplemental restraint system; and
said supplemental restraint system further comprising at least one airbag system and at least one seatbelt system each having at least one airbag and at least one seatbelt, each said at least one airbag system and said at least one seatbelt system corresponding to one of said at least one seat;

2. The advanced vehicle occupant detection and weight responsive classification system of claim 1, wherein said at least one weight sensing unit further comprising at least a load cell being operable for taking weight measurements of at least one occupant in said at least one seat, and for converting said weight measurements into an electrical signal, and communicating said electrical signal to said at least one computerized system.

3. The advanced vehicle occupant detection and weight responsive classification system of claim 1, wherein said at least one computerized system is programmably configured to calculate at least an operating weight value from said electrical signals corresponding to said weight measurements for each said at least one seated occupant and communicating said operating weight value to said supplemental restraint system corresponding to said at least one seat.

4. The advanced vehicle occupant detection and weight responsive classification system of claim 1, wherein each said supplemental restraint system being operatively configured for receiving said at least one operating weight value for said at least one seat and for adjusting an inflation/tension for said at least one airbag/seatbelt with a deployment force/tensional strength and acceleration corresponding to said weight measurements.

5. The advanced vehicle occupant detection and weight responsive classification system of claim 1, wherein said computerized system further configured with at least a memory device, and wherein memory device in association with said load cell, further operable for monitoring the weight on said at least one seat and said computerized system further configured for correcting said weight measurements of at least a changing occupant.

6. The advanced vehicle occupant detection and weight responsive classification system of claim 1, wherein said weight sensing unit further responsive to the weight of at least one seated occupant on said at least one seat, wherein said at least one supplemental restraint system is rendered of sufficient deployment force/tensional strength and acceleration for said airbag/seatbelt to keep said at least one seated occupant on said at least one seat when a collision is sensed, but is not rendered of sufficient deployment force/tensional strength and acceleration for said supplemental restraint system to cause impact injury to said at least one seated occupant.

7. The advanced vehicle occupant detection and weight responsive classification system of claim 1, wherein said weight sensing unit further comprises at least one load cell mounted between said seat mounting structure and a vehicle floor, and wherein each said at least one load cell further configured with at least one strain gauge comprising electrical resistance elements.

8. The advanced vehicle occupant detection and weight responsive classification system of claim 1, wherein said at least one computerized system further disposed with at least one memory device comprising at least one EPROM, and wherein said at least one computerized system further responsive to data for said at least one seated occupant. The vehicle occupant seat detection means and weight responsive classification system of claim

9. The advanced vehicle occupant detection and weight responsive classification system of claim 1, wherein said at least one computerized system further comprises at least one of: an emulator; a processor; an address line; a memory device; at least a software program; a CPU; a CMOS.

10. The advanced vehicle occupant detection and weight responsive classification system of claim 1, wherein said at least one computerized system is responsive to said weight measurements for correcting data about a changing occupant, wherein said weight sensing unit is further configured for sensing weight about the changing occupant and generating a weight signal corresponding to the weight of said changing occupant.

11. The advanced vehicle occupant detection and weight responsive classification system of claim 1, wherein said weight sensing unit operatively configured with said supplemental restraint system in communication with said at least one computerized system, wherein said at least one computerized system further operable for classification and for adjusting the deployment force/speed of said supplemental restraint system for said at least one seat according to the weight and collision force value.

12. The advanced vehicle occupant detection and weight responsive classification system of claim 1, wherein said at least one computerized system further comprising at least a header communicatively connected to a circuit board in association with said at least one EPROM, wherein said at least one EPROM in further association with at least one software program each operatively configured to perform at least one of: run programs, process data, compare weight data, identify new weight data, generate at least a new data if said comparison is significantly different.

13. The advanced vehicle occupant detection and weight responsive classification system of claim 1, wherein said at least one weight sensing unit further configured to measure resistance occurring when external strain is sensed on said at least one seat, and wherein said at least one weight sensing unit further operable for converting said resistance into electrical energy.

14. The advanced vehicle occupant detection and weight responsive classification system of claim 1, wherein said at least one computerized system further comprises a control module, said control module further configured for identifying each seat for which said weight measurements are taken and for activating said at least one supplemental restraint system corresponding to each said seat for which said weight measurement exceeds a minimum weight threshold value generally corresponding to the weight of at least a small child.

15. The advanced vehicle occupant detection and weight responsive classification system of claim 14, wherein said minimum weight threshold value further comprises at least a minimum weight acting on said at least one seat, and wherein said at least one computerized system further configured for converting analog signals to digital signals corresponding to said occupant's weight.

16. The advanced vehicle occupant detection and weight responsive classification system of claim 1, wherein said at least one computerized system further configured to convert digital signals to binary signals corresponding to said operating weight value.

17. The advanced vehicle occupant detection and weight responsive classification system of claim 1, wherein said at least one computerized system is in communication with at least one of: a read only memory device, a basic input-output system, a storage device, a random access memory, each memory operatively configured with at least one software program, said random access memory further operatively configured for accessing said weight measurements.

18. The advanced vehicle occupant detection and weight responsive classification system of claim 1, wherein said supplemental restraint system further comprises at least a deployment unit, each being associated with at least one of: a combustion chamber operatively connected to a canister of igniting gas, a microprocessor being configured for receiving an operating weight value, a microprocessor electrically connected to at least an accelerometer, at least one accelerometer further comprising at least a piezoelectric elements communicatively connected to a canister of igniting gas, a collision sensor operatively connected to a processor in communication with a combustion chamber, a force responsive seatbelt.

19. The advanced vehicle occupant detection and weight responsive classification system of claim 1, wherein said supplemental restraint system further disposed with at least a canister of igniting gas configured with at least a microprocessor, said microprocessor being electrically connected to at least a relay in association with at least one of: a gas release valve, at least an igniter, said relay in communication with said gas release valve for releasing proportionate amount of gas into at least a combustion chamber, said igniter operatively configured for igniting said released gas for at least said airbag deployment.

20. The advanced vehicle occupant detection and weight responsive classification system of claim 1, wherein said supplemental restraint system in association with at least an accelerometer, said accelerometer further comprises at least one piezoelectric elements each comprising at least one of: at least a crystal, at least a coil, said piezoelectric elements communicatively connected to at least a mass, said mass in communication with at least a spring, said spring operatively connected to at least a sliding pot, said sliding pot enabling an opening in said combustion chamber for the release of proportionate amount of igniting gas thereto for said at least one airbag.

21. The advanced vehicle occupant detection and weight responsive classification system of claim 1, wherein said weight sensing unit further configured with at least a microprocessor to enable at least one of: translating said operating weight value into electrical energy proportionate to said weight measurements, controlling said electrical energy to energize at least one accelerometer, translating said electrical energy into mechanical energy, displacing at least a mass to correspondingly compress at least a spring, communicating with at least a sliding pot correspondingly according to said weight measurements, releasing igniting gas through said opening by said sliding pot associated with said airbag assembly.

22. The advanced vehicle occupant detection and weight responsive classification system of claim 21, wherein said accelerometer further configured to transmit a first signal corresponding to said operating weight value to at least a microprocessor associated with said canister of igniting gas, said microprocessor being configured to process said first signal to deliver to said relay a second signal corresponding to a specific volume of gas to be released into said combustion chamber, said specific volume of gas further comprising the amount of igniting gas required to initiate said deployment force and acceleration for said at least one airbag inflation being correspondingly proportionate to said weight measurements.

23. The advanced vehicle occupant detection and weight responsive classification system of claim 23, wherein said accelerometer further comprises at least one piezoelectric element operatively connecting said sliding pot to said combustion chamber for the release of igniting gas into said at least one airbag, wherein said airbag is configured to provide a proportionate inflation pressure when a collision sensor senses a collision has occurred of a severity requiring airbag deployment.

24. The advanced vehicle occupant detection and weight responsive classification system of claim 1, wherein said weight sensing unit further comprises a collision sensor communicatively connected to said at least one computerized system, and wherein said collision sensor further operatively connected to at least one supplemental restraint system.

25. The advanced vehicle occupant detection and weight responsive classification system of claim 24, wherein said collision sensor further operable for sensing collision, and said at least one computerized system further operable for controlling the deployment of airbags in response to a collision severity threshold, and wherein said collision severity further comprises a threshold comprising at least a collision substantially equivalent to said vehicle traveling at least 10 m.p.h. and hitting at least a substantially rigid object.

26. The advanced vehicle occupant detection and weight responsive classification system of claim 1, wherein said at least one computerized system further configured for storing said weight measurements and for erasing said weight measurements for said at least one seat when said occupant leaves said at least one seat, wherein at least a new weight measurement is generated responsive to said weight of said new occupant sitting on said at least one seat, and wherein said weight sensing unit further comprises a detection apparatus operatively configured for detecting weight and for measuring weight capacity of at least 1 pound.

27. The advanced vehicle occupant detection and weight responsive classification system of claim 1, wherein said computerized system further comprising signal amplifier apparatus being configured for amplifying at least one of: analog signal, digital signal, binary signals, wherein said at least one signal is provided for controlling said supplemental restraint system, further comprising a transient voltage suppressor communicatively connected to said at least one computerized system, said transient voltage suppressor being further configured to filter out at least one of: transient spikes, transient force, travelling current, preventing abnormal readings, preventing abnormal communication signals to said airbag assembly.

28. The advanced vehicle occupant detection and weight responsive classification system of claim 1, wherein said at least one computerized system further operable for calculating a restraint value for said supplemental restraint system based upon at least the weight value of said at least one seated occupant and/or at least a collision force value according to the vehicle speed, and wherein said supplemental restraint system further configured for controlling force/tension when a collision is sensed.

29. The advanced vehicle occupant detection and weight responsive classification system of claim 1, wherein said weight sensing unit further operable for converting said occupant's body weight into electrical energy for controlling the deployment force/tensional strength, and wherein said weight sensing unit further comprising at least a strain gauge being disposed with a load cell.

30. The advanced vehicle occupant detection and weight responsive classification system of claim 29, wherein said wherein said load cell further comprising at least a silicon substrate load sensing device, and said weight sensing unit further comprises apparatus for detecting seat occupancy, in communication with said computerized system operable for controlling the resistance of said supplemental restraint system.
